(19) United States
(12) Patent Application Publication
(10) Pub. No.: US 2019/0247788 A1
(43) Pub. Date: Aug. 15, 2019

(54) BLOCK APPARATUS FOR USE WITH OXIDIZERS

(71) Applicant: Dürr Systems Inc., Plymouth, MI (US)

(72) Inventor: Daniel Widhalm, Southfield, MI (US)

(21) Appl. No.: 15/894,661

(22) Filed: Feb. 12, 2018

(51) Int. Cl. B01D 53/44; B01J 35/04; F27D 1/00; F27D 1/12; F27D 1/14

(52) U.S. Cl. CPC B01D 53/44; B01J 35/04; F27D 1/147; F27D 1/12; F27D 1/0006

(57) ABSTRACT

Block apparatus for use with oxidizers are disclosed. An example apparatus includes a converter including a block having a plurality of channels extending therethrough. The channels define a cellular pattern including at least one central channel and a plurality of surrounding channels. Protrusions extend into the channels from respective inner surfaces of the channels. The inner surfaces are defined by respective peripheral walls.

### FIELD OF THE DISCLOSURE

This disclosure relates generally to converters and, more particularly, to block apparatus for use with oxidizers.

### BACKGROUND

Oxidizers have blocks (e.g., refractory elements) with a refractory material and exchange heat between the blocks and a gaseous or liquid flow. Typically, thermal efficiency and agglomeration resistance are issues with the matrices/media/block.

### BRIEF DESCRIPTION OF THE DRAWINGS

FIG. 1A shows an example oxidation system having a set of towers.

FIG. 1B is a view of the oxidation system of FIG. 1 depicting the representative zone definitions of the system.

FIG. 1C is a view of another example oxidation system depicting flow switching towers.

FIG. 1D is a view of another example oxidation system depicting flow switching towers with alternating inlets as a function of time.

FIG. 2 is a view of a standard block profile of an example block.

FIG. 3 is a view of another example block viewed in a direction along axes of channels.

FIG. 4 is a view of another example block having different effective widths.

FIG. 5 depicts example irregular-shaped blocks and illustrates effective block heights.

FIG. 6 is an enlarged cross-sectional view of another example block having a four-sided polygon channel shape.

FIG. 7 is an enlarged cross-sectional view of four-sided channels in another example block.

FIG. 8 is an enlarged cross-sectional view of another example block containing hexagonal channels.

FIG. 9 is an enlarged cross-sectional view of another example block containing hexagonal channels.

FIG. 10A is an enlarged cross-sectional view of another example block with round channels.

FIG. 10B is an enlarged cross-sectional view of another example block with round channels in accordance with teachings of this disclosure.

FIG. 10C is an enlarged cross-sectional view of another example block.

FIG. 10D is an enlarged cross-sectional view of a hexagonal structured example channel.

FIG. 11A is an isometric view of another example block associated with a matrix/media/block design.

FIG. 11B is detailed view of an example wall of the block of FIG. 11A having a matrix/media/block design.

FIG. 12 is a view of the example block of FIG. 11A viewed in a direction along axes of channels.

FIGS. 13A, 13B, 14A, 14B, 15, and 16 are views of the example block of FIG. 11A viewed in a direction along axes of channels and show example protrusions.

FIG. 17 is an isometric view of another example block associated with a polygon design.

FIGS. 18-22, 23A, 23B, 24A, 24B, 25A, and 25B are views of the example block of FIG. 17 viewed in a direction along axes of channels and show example protrusions.

FIG. 26 is an enlarged cross-sectional view of another example channel of another example block depicting points of stagnation.

FIG. 27 depicts views of another example block illustrating possible modifications to walls surrounding channels at the inlet and/or outlet walls of the block.

FIG. 28 is a table representing the production capable design parameters found within another example block with a width of 150 mm.

FIG. 29 is a table representing resultant block data for system performance of the example block of FIG. 28.

FIG. 30 is a flowchart depicting an example process that may be implemented to calculate values for agglomeration resistance.

FIG. 31 is another flowchart depicting another example process that may be implemented to calculate values for thermal efficiency.

FIG. 32 illustrates an example system to implement the processes of FIGS. 30 and 31.

To clarify multiple layers and regions, the thickness of the layers may be enlarged in the drawings. Wherever possible, the same reference numbers will be used throughout the drawing(s) and accompanying written description to refer to the same or like parts.

### DETAILED DESCRIPTION

Apparatus and methods to improve agglomeration/plug resistance and/or thermal efficiency for blocks of oxidizers are described herein. Although thermal oxidizers are described, the described methods and apparatus may apply to other converter blocks including selective catalytic reducers (“SCRs”), etc. One described example apparatus includes a converter including a block having a plurality of channels extending therethrough. The channels define a cellular pattern including at least one central channel and a plurality of surrounding channels. Protrusions extend into the channels from respective inner surfaces into the channels, where the inner surfaces are defined by respective peripheral walls (e.g., inner channel peripheral walls). In some examples, the peripheral walls preferably extend along an axis of the channels and can at least partially enclose at least one channel within two dimensions that are perpendicular to the channel's axis.

Another example apparatus includes a block for a converter. The block has a plurality of channels extending therethrough defining a cellular pattern including at least one central channel surrounded by a plurality of peripheral channels. The apparatus also includes a first protrusion extending at least partially into the channel from a peripheral wall (e.g., an inner channel peripheral wall). In some examples, the peripheral wall can encompass an outer wall of the block.

Another example apparatus includes a converter including a block having a plurality of channels extending therethrough. The channels define a cellular pattern including at least one central channel and a plurality of surrounding channels. The block includes a plurality of corrugated walls at least partially defining the cellular pattern.

An example method includes producing a converter including a block having a plurality of channels extending therethrough. The channels define a cellular pattern including at least one central channel and a plurality of surrounding channels. Protrusions extend into the channels from respective inner surfaces of the channels, where the inner surfaces are defined by respective peripheral walls.

Another example method includes producing a converter including a block having a plurality of channels extending therethrough. The channels define a cellular pattern including at least one central channel and a plurality of surrounding channels. The block includes a plurality of corrugated walls at least partially defining the cellular pattern.

Some of the examples described relate to matrices containing refractory materials or other similar materials found within thermal oxidizing systems. Refractory material retains its shape and structure at high temperatures and may comprise ceramics, clay materials, silica, zirconia, alumina, and/or oxides such as lime and magnesia. The main classifications of refractory material may include clay-based, alumina-based, magnesia, dolomite, carbonates, silica, zircon, etc. Precious metals and iron-based refractory materials also exist.

A thermal oxidation block exchanges heat between the block and a gaseous or liquid flow of a stream passing through the block. The stream is heated in a chamber, in which the fluid is chemically converted in what is often an exothermic reaction (e.g., exothermally oxidizes). The examples disclosed relate to cross-sectional designs of the blocks (e.g., refractory elements). The examples disclosed also describe calculating the dimensional characteristics for channels (e.g., cells, passages), or any other relevant critical features. Parameters for defining the gaseous or liquid flow through the block may include a channel hydraulic diameter, an inner wall width and an outer wall width. These parameters are related to fluid properties of the flow and thermal characteristics of the system and also affect the eventual plugging of the block. The hydraulic diameter relates the cross-sectional area to its respective perimeter and is used for calculating a Reynolds number for pipe flow. Plugging may occur as the gas or liquid containing impurities imparts particles onto the channels, which may adhere to surface walls of the channels, and, eventually, these particles may plug (e.g., clog) the channels. Plugging may be reduced by use of an anti-adhesive coating (e.g., a silicon resistance coating) or a catalytic coating. The catalytic coating, which contains a catalyst, may be applied in an SCR process to further neutralize the harmful compounds present. Further, in some examples, plugging is further reduced and/or eliminated by use of one or more protrusions in a channel. In particular, a protrusion may be positioned on a peripheral wall forming the channel in an area of stagnation and/or a stagnation point in which agglomeration typically occurs.

Thermal oxidizer blocks generally use blocks with square channel designs. The edges of the square channels are usually aligned (i.e., sets of rows are not offset from one another). The equations and ratios described below are related to an improved channel (e.g., cell) design in comparison to known hydraulic diameter and square channel designs. The system performance improvements seen by the examples described may be one or more of a combination of efficiency, streamlining or resistance to agglomeration (e.g., plugging), thermal convection, flow stagnation, pressure differential and destruction removal efficiency (“DRE”). The DRE is a measure of destruction of harmful gases (e.g., volatile organic compounds (“VOCs”)). Destruction of the VOCs occurs when the VOCs oxidize (e.g., become other compounds) as they are heated. The DRE is calculated by dividing the mass or volume of the VOCs exiting by the mass or volume of the VOCs that enters the oxidizer (e.g., 10 lbs. of VOCs enters while 1 lb. of the VOCs exits results in a corresponding 90% DRE). Critical features of the block may be limited by current production technology, which may include extruding and stamping (e.g., the limitations may include arrangement of the channels, size of the channels, amount of the channels in a defined area, etc.).

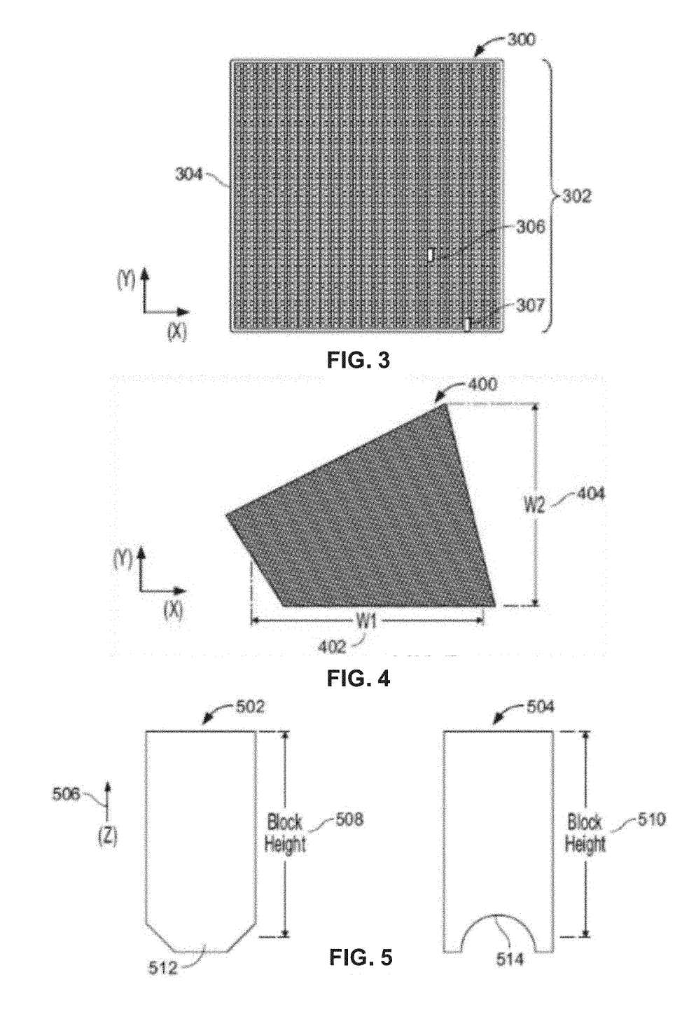

The examples described herein improve the system efficiency and/or resistance to plugging (e.g., increase the time until the blocks become clogged or plugged) in conjunction with at least one other system performance factor. One described example block employs a heat transfer regenerative mass and has a plurality of channels for the exchange of heat between the fluid and the block. Geometry of the block channels is designed to increase efficiency and/or resistance to plugging, and manufactured to provide a cross-sectional structure to improve the system performance factors. The interior channel wall thicknesses of the blocks and interior protrusions may be defined by multiple factors to enhance the performance of the blocks within known manufacturing limitations. Additionally, the geometry of a boundary of the block itself (e.g., outer wall) may be adjusted to further improve overall performance of the system: Though the standard shape is square as in FIG. 3, the preferred shape is a parallelogram. Further, in some examples, geometries of channel protrusions are designed to increase and/or maximize resistance to plugging and/or thermal efficiency of a block.

The design of the geometry of the channels (e.g., a polygon design and/or a corrugated design) with/out protrusions and the spacing between the channels significantly effects the overall performance of the block and, therefore, the thermal oxidizer; the system. Additionally, the shape of the channels (e.g., round, hexagonal, octagonal, square, parallelogram, ellipse, oval, etc.) may also significantly affect thermal efficiency, plug resistance, and numerous other measures of performance. Utilizing a round profile channel surrounded by at least six other surrounding channels may significantly improve thermal efficiency over other channel arrangements. Likewise, utilizing a hexagonal or octagonal profile surrounded by six other surrounding channels may significantly improve resistance to plugging. In some disclosed examples, utilizing a corrugated profile and/or design for a block effectively reduces and/or eliminates plugging associated with the block.

Time to plugging is a variable that is necessary to be accounted for, in conjunction with thermal efficiency. Particle growth models provide an ability to account for particle coalescence and, thus, plugging. The examples described in accordance with the teachings of this disclosure describe channel geometries and arrangements that substantially improve thermal efficiency and/or plug resistance.

Although certain geometries of the channels are described, the geometry of the channels may vary and include shapes such as a shape having greater than four sides which may contain sharp and/or rounded edges. Other channel geometries may include shapes which may contain intersecting tangent angles that are less than 90 degrees, shapes consisting of straight or spline segments, shapes containing polygons with a combination of splines, and/or any other appropriate shapes to allow fluid to flow through the channels.

Some oxidizer systems may involve switching or reversing between stacks (e.g., towers) of blocks in fluid communication with a combustion chamber. In scenarios in which it is desirable to keep the fluid or gas at relatively elevated temperatures as the fluid or gas is provided to the combustion chamber, the blocks themselves heat the fluid or gas on a second cycle after the directions are reversed (e.g., the outlet on the previous cycle becomes an inlet the next cycle). In some examples, the blocks may have sharp (e.g., “knife-like”) edges proximate an inlet and/or outlet of the blocks to further improve plug resistance of the blocks.

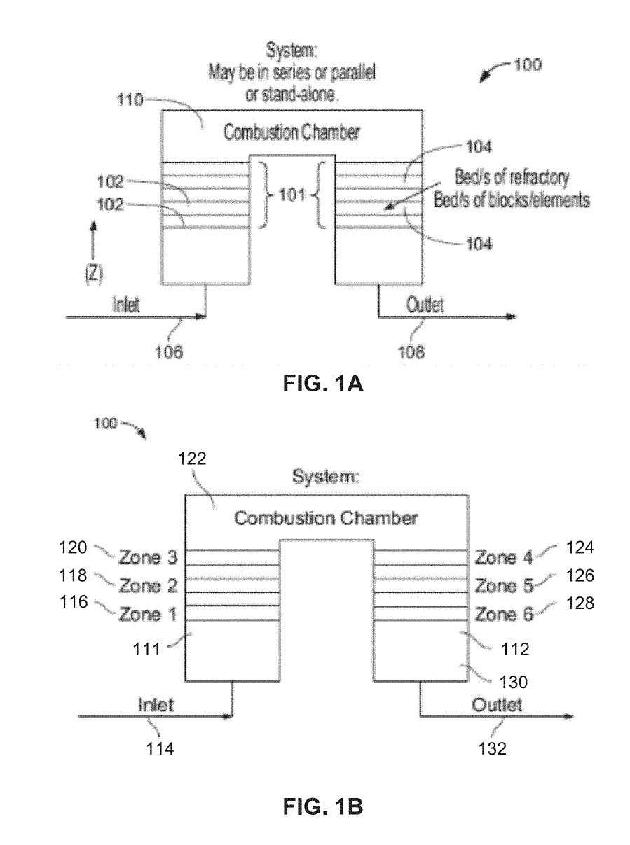

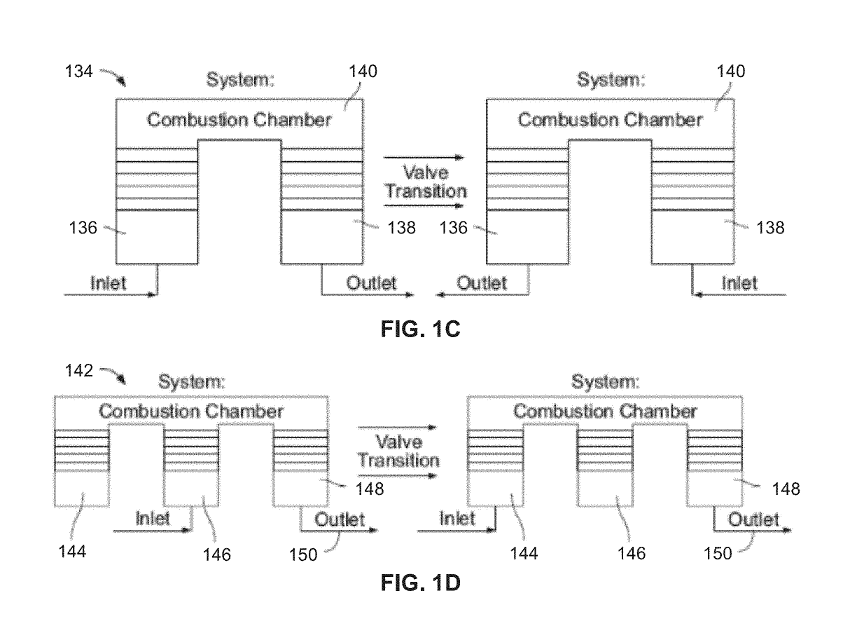

FIG. 1A shows an example oxidation system 100 having a set of towers. The system 100 may also be represented as a rotating or circular system, or any other structure or appropriate combination of structure types. In any case, beds 101 are comprised of a set of blocks 102 and blocks 104, which may be substantially identical or different. The blocks 102 are adjacent to an inlet 106 and the blocks 104 are adjacent to an outlet 108. The blocks 102, 104 utilize a unidirectional heat transfer path (e.g., the fluid is heated and cooled in the blocks 102, 104 without the use of another flow) and may have a refractory material and comprise a ceramic material, brick, metal, precious metal, silica/s, clay, carbides, graphites or be made of any appropriate material stable at high temperatures. Different types of blocks 102, 104 may be used in the oxidation system 100. Additionally, the blocks 102, 104 may be produced from stamping, extruding, molding or any other appropriate manufacturing process. In contrast to the blocks 102, 104, heat exchangers utilize bi-directional flows (e.g., two or more fluids crossing paths in a countercurrent arrangement).

In operation, fluid flows from the inlet 106 and into the blocks 102. As the fluid moves through the blocks 102, heat is transferred from the blocks 102 to the fluid. After the fluid passes through the blocks 102, the fluid flows into a combustion chamber 110, where the fluid is heated. Although the combustion chamber 110 is shown, any appropriate type of heating chamber may be used. Heating the fluid oxidizes the fluid and allows some impurities (e.g., VOCs) to be taken out (e.g., burned-off). After being heated, the fluid then moves into the blocks 104. As the fluid moves through the blocks 104, heat is transferred from the fluid to the blocks 104. Finally, the fluid flows out of the oxidation system 100 through the outlet 108.

FIG. 1B is another view of the oxidation system 100 depicting representative zone definitions of the system 100. Towers 111 and 112, in this example, do not alternate functions as shown in connection with FIGS. 1C and 1D. An inlet zone 114 is where the incoming waste fluid (e.g., raw waste gas or stream) enters the system 100. A portion 116 (e.g., “Zone 1”) directs the waste fluid through the face of a bed of blocks or media. A portion 118 (e.g., “Zone 2”) lies between the portion 116 and a portion 120 (e.g., “Zone 3”) and the waste fluid simply passes through the portion 118. The portion 120 exhausts the waste fluid into a combustion zone 122. The combustion zone 122 is a primary oxidation zone. A portion 124 (e.g., “Zone 4”) accepts the oxidized flow from the combustion zone 122. A portion 126 (e.g., “Zone 5”) lies between the portion 124 and a portion 128 (e.g., “Zone 6”). The portion 128 directs the oxidized fluid through an exhaust face 130. An outlet zone 132 directs oxidized fluid away from the system 100. The features and design of the inlet 114 are process dependent and may depend upon system requirements. Portions 116, 118, 120, 124, 126, 128 are delineated by their respective temperature gradients with respect to height

$$( i . e . , \frac{\partial T}{\partial z} ) .$$

As seen by fundamental equation 16, which is described below in connection with FIG. 34, the slopes will vary in relationship to the combustion zone 122 and the inlet zone 114 or the outlet zone 132. The zones described here may vary, however, the fundamental conditions which occur through portions will remain consistent with respect to the variables presented in a particular system. Additionally, the system 100 may also have valves which direct the flow between the different and portions and between the different towers.

FIG. 1C is a view of an oxidation system 134 depicting flow switching towers 136, 138 cycling (e.g., alternating) between being an inlet or an outlet as a function of time. This alternating preheats fluid prior to entering combustion chamber 140 by utilizing the heat added to the current inlet (e.g., the outlet on the previous cycle) from the heated fluid exiting the chamber 140 on the previous cycle. This transition may occur periodically or may be dependent on certain conditions (e.g., desired DRE, temperature conditions of the environment or the oxidation system 134, etc.). During this valve transition, a spike in the DRE may occur. A “dead” volume attributed to the spike in DRE is volume that is dormant during a transition period.

FIG. 1D is a view of an oxidation system 142 with switching towers 144, 146 alternating as inlets (e.g., transitioning). In this example, a tower 148 remains the outlet tower. Similar to oxidation system 134, this transition between switching towers 144, 146 may occur periodically or may be dependent on certain conditions (e.g., desired DRE, temperature conditions of the environment or the oxidation system 142, etc.) and may occur through mechanically switching valves. The valve transition may also occur through any other mechanical device or any appropriate combination of electrical and mechanical devices. Similar to the oxidation system 134, during the valve transition, a spike in the DRE may occur. The tower 148, which is not attached to the switching towers 144, 146, exhausts oxidized gas to an outlet stream 150.

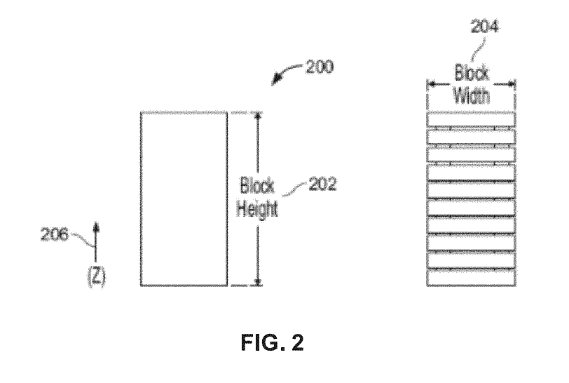

FIG. 2 is a view of a standard block profile of a block 200, which is used here to represent numerous different block profiles. A block height 202 (e.g., “Z” or “H-block”) is the effective height of the block and a block width 204 (e.g., “X”) is the effective width of the block and equal to a depth (e.g., “Y”, which is not shown). In scenarios in which cuts or openings are present in the block 200, or if the block 200 has an irregular shape, an altered mass center of gravity will have to be taken into account with respect to the flow parameters. The main flow direction (e.g., “Z”) is indicated by an arrow 206.

FIG. 3 is a view of a block 300 viewed in a direction along axes of channels 302. A block may vary due to manufacturing feasibility and/or system requirements defined by a customer and/or a responsible party, and vary based upon factors including required thermal efficiency, time to plugging, manufacturability, cost, space-constraints, etc. The block 300 has a width consistent with X and Y described above in connection with FIG. 2. The block 300 may also have a surrounding wall 304, which encloses the channels 302, and may have a thickness greater than or equal to inner wall thicknesses defined by the channels 302. While the block 300 is depicted as having a square shape, it may have any appropriate shape including, but not limited to, round, oval, hexagon, octagon, wedged, rectangular, parallelogram, etc. The block 300 may also have slits 306 and/or grooves 307 on an exterior or interior of the block 300 to fluidly couple a portion of the channels 302. The slits 306 may have a minimum width of approximately 0.25 mm and minimum depth of 0.1 mm. Recommended dimensions for the slits 306 are approximately less than 0.5 mm in width and less than 50 mm in length to properly allow fluid communication between the channels 302, or any other appropriate size. The width of the slits 306 and/or the grooves 307 may be approximately greater than or equal to one-third of the inner wall thickness to allow proper fluid flow between the slits 306. These dimensions are the result of tooling and fluid dynamic analysis. In examples where the hydraulic diameter is on the order of the inner wall thickness, relatively high pressures may drive the flow through a normal path, however, if the flow through the normal path is choked, then the flow may travel through the slits 306 and between the channels 302. Additionally or alternatively, a silicon-resistant coating (e.g., paraffin, etc.) may be applied to the channels 302 in order to further resist plugging.

FIG. 4 is a view of a block 400 with a consistent mass and flow distribution in Z (direction into the page) while being offset in a direction 402 and a direction 404. These offsets correspond to the block 400 having differing effective widths in the directions 402, 404. Note that block variations may exist at any point within the mass of refractory channels and may be of any shape comprising splines, lines and/or curves. Geometric variations and irregularities of block shapes may be accounted for with the examples described below.

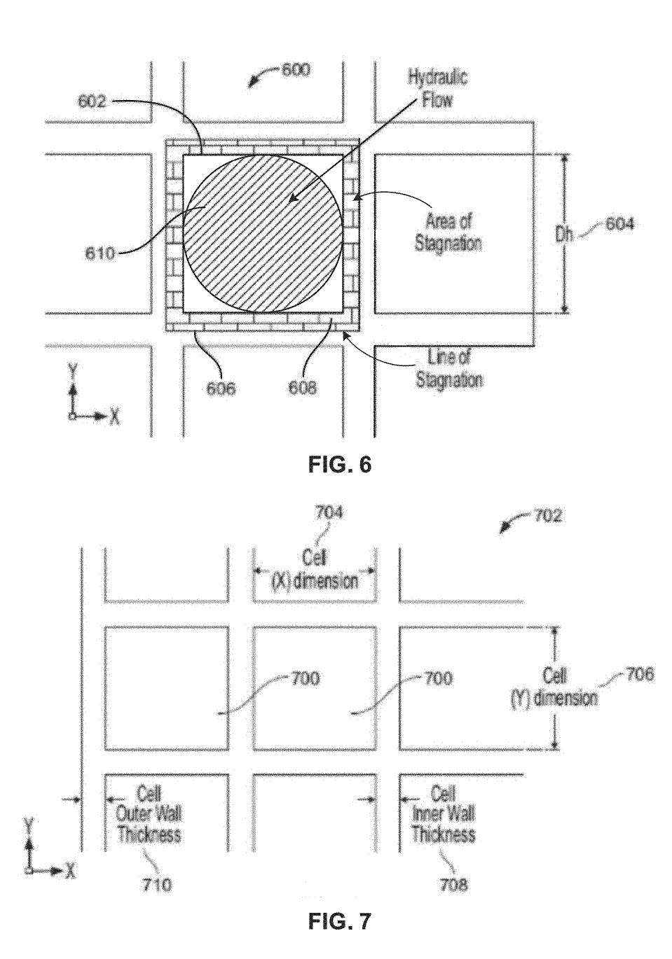

FIG. 5 depicts irregular-shaped blocks 502 and 504, and illustrates effective block heights. An arrow 506 indicates a direction of fluid flow. Effective block heights 508, 510 for the blocks 502, 504, respectively, illustrate how irregularities such as a rounded contour 512 and a notch 514 may be accounted for. As mentioned above in connection with FIG. 4, block variations may exist at any point within the mass of refractory and may be of any shape representable by any combination of splines, lines and/or curves.

FIG. 6 is an enlarged cross-sectional view of a block 600 containing a channel 602 representative of a four-sided polygon, which is used as a baseline for comparisons. The flow direction is normal to the page. A dimension 604 indicates a graphical representation of the hydraulic diameter (e.g., “Dₕ”). A line of stagnation 606 delineates adjoining channels or other features which are the theoretical stagnation point(s) relating to the flow conditions, and is a function of the geometry of the channel 602. An area of stagnation 608 is the zone between the line of stagnation 606 and a hydraulic flow 610, which indicates the main flow area, and is not affected by the boundaries of where the fluid is in contact with surfaces of the channel 602.

FIG. 7 is an enlarged cross-sectional view of four-sided polygon channels 700 in a block 702, which are commonly referred to as square channels, and have a substantially square shape (i.e., a dimension 704 represented by “X” is substantially equal to a dimension 706 represented by “Y”). A dimension 708 indicates the thickness of the inner walls defined by the channels 700 and a dimension 710 indicates the thickness of the outer walls of the block 702.

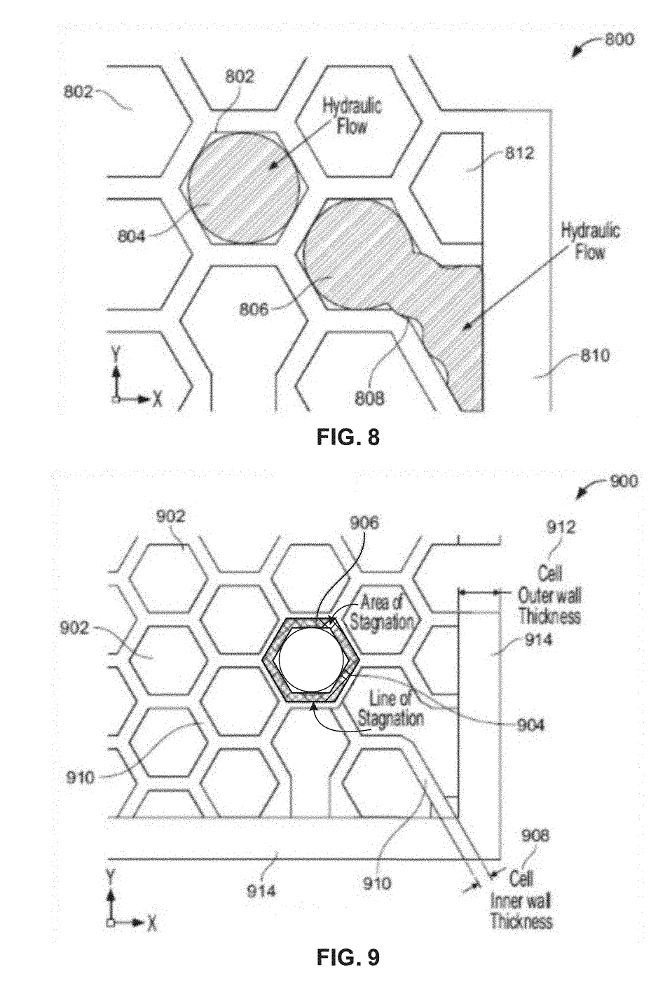

FIG. 8 is an enlarged cross-sectional view of a block 800 containing hexagonal channels 802. A hydraulic flow 804 is representative of a relatively low mean velocity passing through the channel 802. A relatively low mean velocity is that which is comparable to

$$300 \frac{SCFM}{{ft}^{2}} or 5100 \frac{N m 3}{hr {m}^{2}} .$$

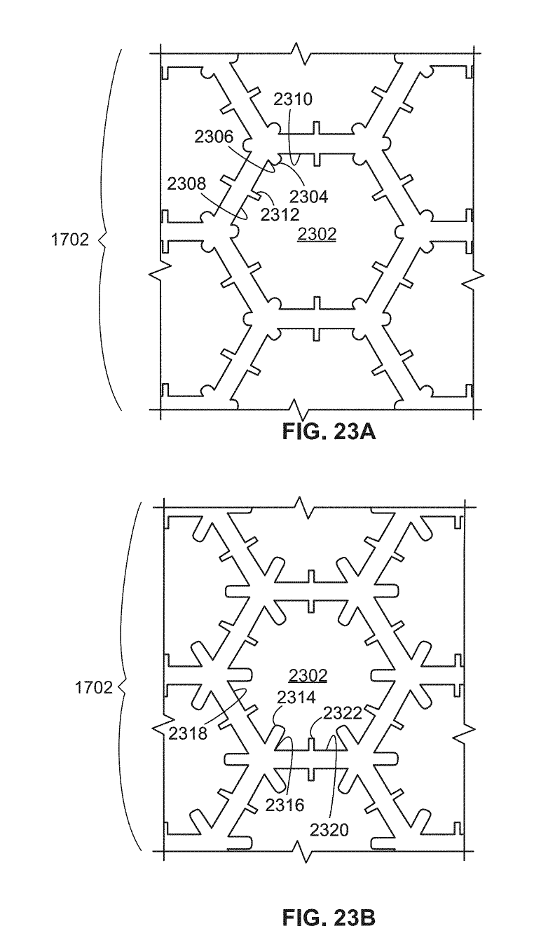

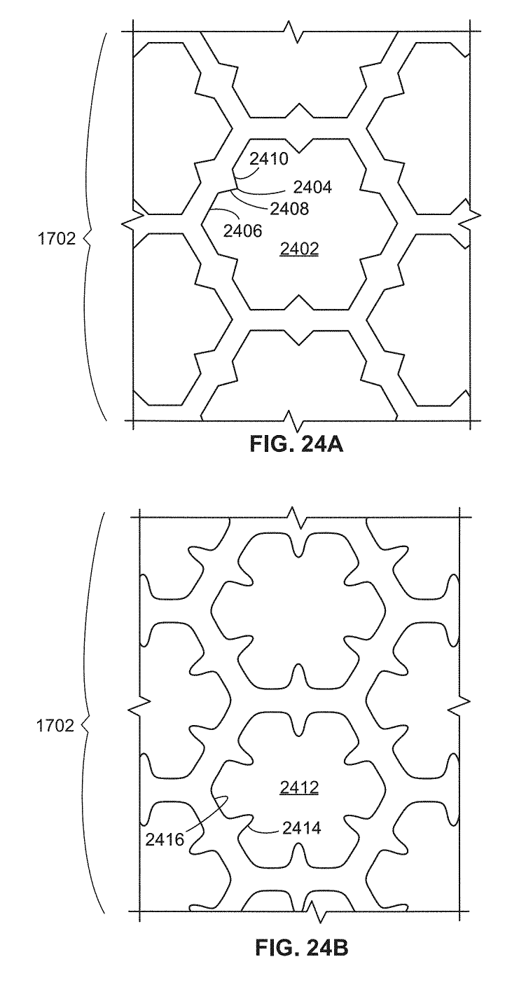

Dₕ, the hydraulic diameter relating the possible flow to its perimeter, which is found through equation 4, is described below in connection with FIG. 23. This calculation is applicable to channel velocities between

$$0.1 \frac{m}{s} and 100 \frac{m}{s} .$$

A hydraulic flow 806 is shown in an irregular channel 808. The irregular channel 808 may result from edge effects near an outer edge 810. These edge effects/irregularities may result from the manufacturing processes (e.g., extruding or stamping, etc.) or an intended design to maintain a vertically constant wall thickness in the outer edge 810 (i.e., as shown in another irregular channel 812).

FIG. 9 is an enlarged cross-sectional view of a block 900 with hexagonal channels 902. A line of stagnation 904 delineates the mean value between two or more zones of flow. An area of stagnation 906 is determined by subtracting the live or hydraulic flow zone away from the total occupied area of the channel 902. For calculations, which will be described below in greater detail in connection with FIGS. 33 and 34, a channel inner wall thickness 908 is the mean value of all the thicknesses of inner walls 910, weighted appropriately with respect to the channel flow. Similarly, an outer wall thickness 912 is the mean value of all of outer walls 914 weighted appropriately with respect to the block-edge flow. The parameters pictorially shown in connection with FIGS. 8 and 9 are applicable to the calculations described in connection with FIGS. 33 and 34.

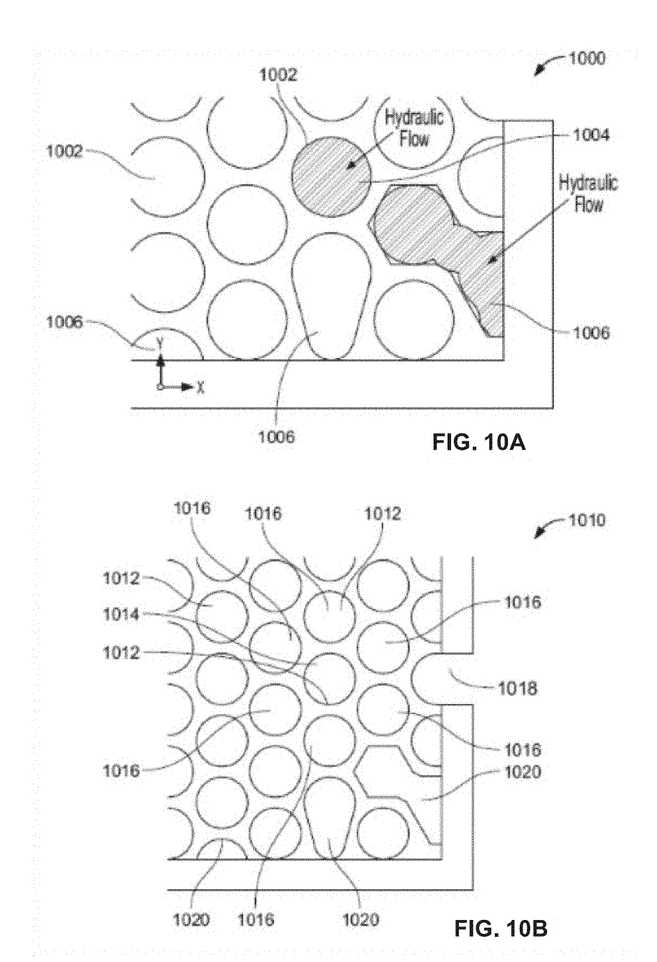

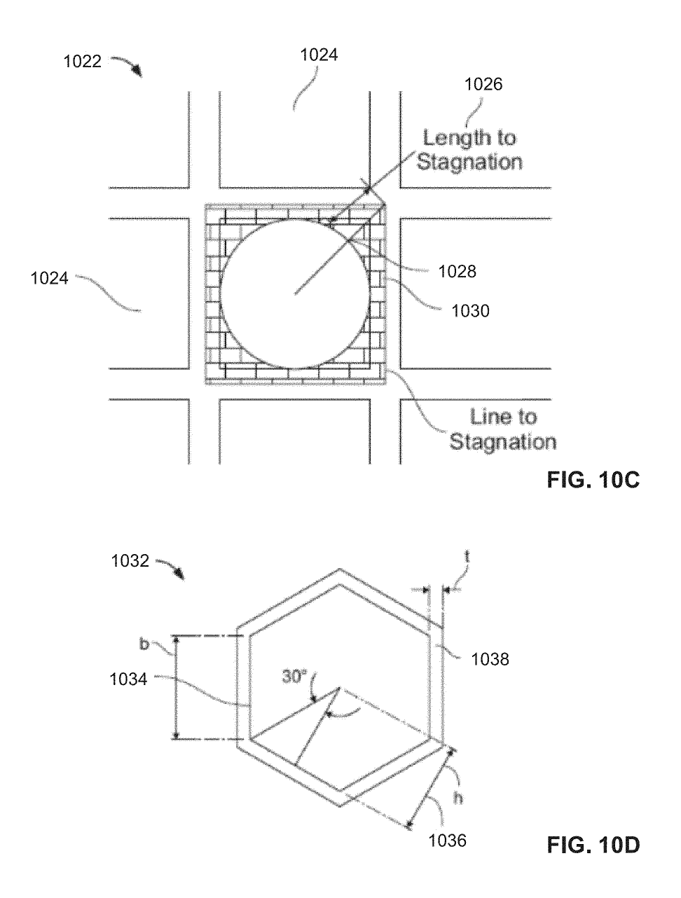

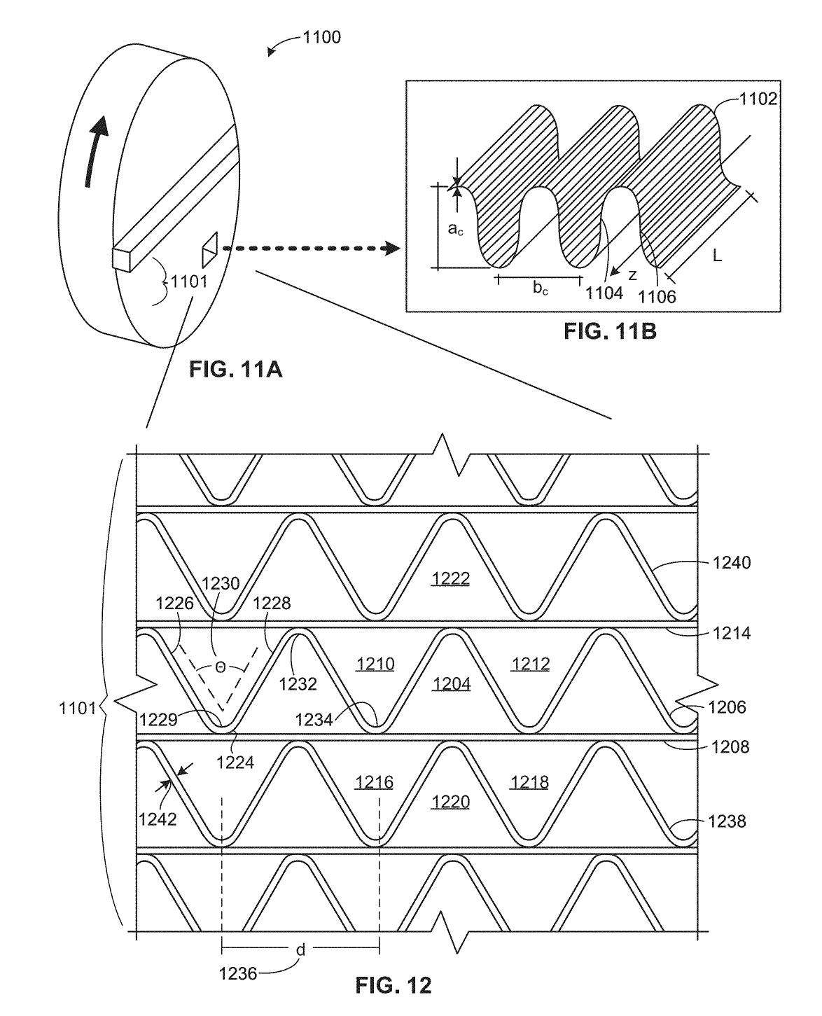

FIG. 10A is an enlarged cross-sectional view of a block 1000 with round channels 1002. A hydraulic flow area 1004 of the round channels 1002, by definition, is equivalent to the area of each of the round channels 1002. The round channels 1002 may be surrounded by irregular channels 1006 because of the edge effects described above in connection with FIG. 8.

FIG. 10B is an enlarged cross-sectional view of a block 1010 with round channels 1012 in accordance with the teachings of this disclosure. A central round channel 1014 is surrounded by six surrounding channels 1016 in a cellular pattern. The surrounding blocks 1016 may be substantially equidistant to the center channel 1014. Although the surrounding blocks 1016 are shown in a substantially equiangular arrangement, they may not necessarily be arranged in the equiangular arrangement. Surrounding the central channel 1014 by six other channels 1016 may result in the largest thermal efficiency, as described in further detail below in connection with FIG. 34. The block 1010 may also include a notch 1018 on the exterior or interior of the block 1010 and/or irregular channels 1020 near a periphery of the block 1010. The pattern of arrangement of the channels 1012 may include sub-patterns of the central channels 1014 surrounded by surrounding channels 1016. Each of the central channels 1014 may have a varying (e.g., substantially non-constant) inner wall thickness around a perimeter of the central channel 1014.

FIG. 10C is an enlarged cross-sectional view of a block 1022 containing channels 1024. A length to stagnation 1026 is defined as the distance from a flow area 1028 to a stagnation line 1030.

FIG. 10D is an enlarged cross-sectional view of a hexagonal structured channel 1032 with a side length 1034 (e.g., “b”), a distance to the center 1036 (e.g., “h”), and an inner wall thickness 1038 (e.g., “t”).

FIG. 11A is a view of an example block 1100 in which examples disclosed herein may be implemented. The block 1100 of FIG. 11A may correspond to any one or more of the previously disclosed blocks 102, 104, 200, 300, 400, 502, or 504. In particular, the block 1100 of FIG. 11A includes a cellular pattern (e.g., a corrugated pattern) defined by a plurality of channels 1101 extending therethrough, as disclosed further below. While the example of FIG. 11A depicts the block 1100 to be circular, in other examples, the block 1100 may be shaped differently (e.g., rectangular, square, wedge, oval, etc.).

FIG. 11B is a detailed view of the block 1100 of FIG. 11A and shows a corrugated design of the block 1100. In particular, FIG. 11B depicts an example wall 1102 extending through the block 1100 having a corrugated shape. In some examples, the example wall 1102 of FIG. 11A at least partially defines the cellular pattern in the block 1100 with one or more other walls, some or all of which may be similar and/or different relative to the example wall 1102, as disclosed further below.

The example wall 1102 of FIG. 11B includes a first surface (e.g., a flat surface) 1104 that is substantially parallel relative to a second surface (e.g., a flat surface) 1106. That is, a plane defining the first surface 1104 and a plane defining the second surface 1106 form an angle between about −5 degrees to 5 degrees. However, in other examples, the first surface 1104 and the second surface 1104 form angles less than 5 degrees or greater than 5 degrees.

FIG. 12 is a view of the block 1100 of FIG. 11A viewed in a direction along axes of the channels 1101 extending through the block 1100. In the example of FIG. 12, the channels 1101 are defined by a plurality of walls (e.g., corrugated walls and/or flat walls).

As shown in FIG. 12, a first channel (e.g., a central channel) 1204 is formed by a first wall (e.g., a corrugated wall) 1206 and a second wall (e.g., a flat wall) 1208. The first wall 1206 of FIG. 12 at least partially defines a second channel (e.g., a peripheral channel) 1210 and a third channel (e.g., a peripheral channel) 1212 adjacent and/or positioned on opposite sides of the first channel 1204. In the example of FIG. 12, the second channel 1210 and the third channel 1212 are formed by the first wall 1208 and a third wall (e.g., a flat wall) 1214. The first wall 1206 of FIG. 12 is interposed between the second wall 1208 and the third wall 1214.

In the example of FIG. 12, the first channel 1204 is surrounded by the second channel 1210, the third channel 1212, a fourth channel 1216, a fifth channel 1218, a sixth channel 1220, and a seventh channel 1222, each of which may be referred to as a peripheral channel. While FIG. 12 depicts the first channel 1204 to be a central channel, in other examples, one or more of the other channels 1101 of the block 1100 may, likewise, be considered central channels surrounded by peripheral channels.

In the example of FIG. 12, the channels 1101 are at least partially defined by corrugations positioned on some of the walls of the block 1100. For example, the first wall 1206 of FIG. 12 includes a first portion (e.g., a curved and/or a folded portion) 1224 defining adjacent surfaces 1226, 1228 (i.e., a first surface 1226 and a second surface 1228). In some examples, the first portion 1224 has a concave surface 1229 extending along a circular path and/or a radius (e.g., about 0.5 millimeters). As previously disclosed, in some examples, the first surface 1226 and the second surface 1228 formed by the first portion 1224 may be substantially parallel relative to each other. However, in the example of FIG. 12, the surfaces 1226, 1228 are angled relative to each other. For example, an angle 1230 formed by the first surface 1226 and the second surface 1228 is about 60 degrees.

As shown in FIG. 12, the first wall 1206 of FIG. 12 includes other curved and/or folded portions similar and/or different relative to the first portion 1224. For example, the first wall 1206 includes a second portion (e.g., a curved and/or a folded portion) 1232 adjacent thereto as well as a third (e.g., a curved and/or a folded portion) portion 1234 adjacent the second portion 1232, where the second portion 1232 is positioned between (e.g., centered between) the first portion 1224 and the third portion 1234. The first portion 1224 of FIG. 12 is spaced from the third portion 1234 by a distance (e.g., about 3.5 millimeters) 1236. Similarly, in some examples, other portions of the first wall 1206 may likewise be spaced by the distance 1236 or a different distance.

In the example of FIG. 12, corrugations of the walls are aligned. For example, as shown in FIG. 12, corrugations associated with the first wall 1206, a fourth wall 1238, and a fifth wall 1240 are generally aligned to one another. For example, a central axis of the first channel 1204, a central axis of the sixth channel 1220, and a central axis of the seventh channel 1222 are positioned on the same vertical axis (in the view of FIG. 12). Stated differently, folds and/or curves formed by the first wall 1206, the fourth wall 1238, and the fifth wall 1240 of the block 1100 are positioned along the same vertical axis (in the view of FIG. 12). While the example FIG. 12 depicts all of the corrugated walls of the block 1100 being aligned to one another, in other examples, corrugations of at least some (e.g., all) of the walls are not aligned and/or offset relative to one another.

In the example of FIG. 12, each of the walls of the block 1100 has a thickness 1242 that may be substantially similar or the same relative to each other wall. In some examples, each wall of the block 1100 has a nominal thickness associated therewith between about 0.085 millimeters to 3 millimeters.

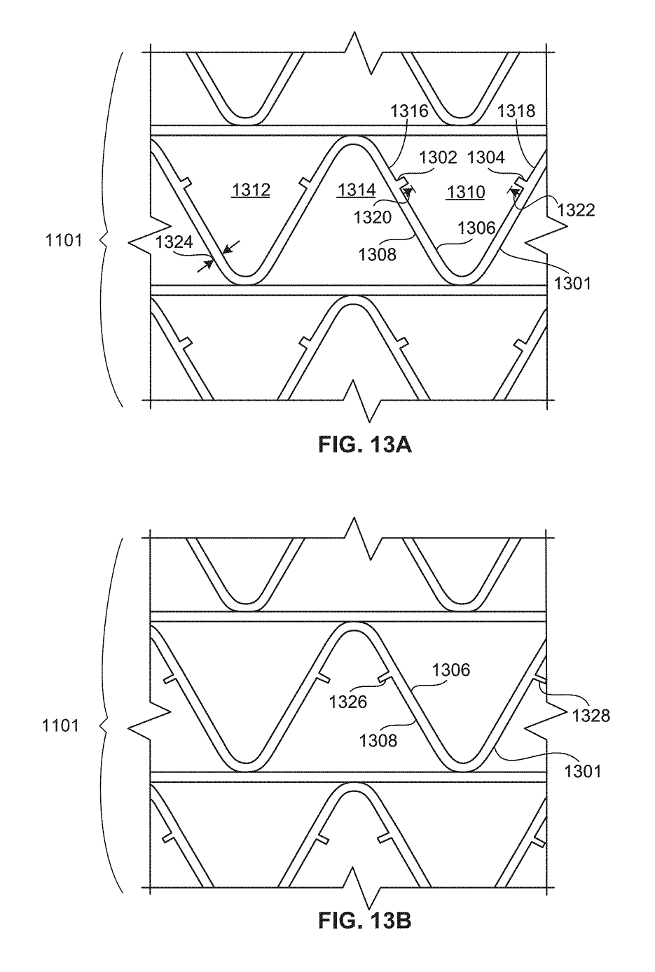

FIGS. 13A and 13B are views of the block 1100 of FIG. 11A viewed in a direction along axes of the channels 1101 and show example protrusions (e.g., tabs, nubs, bumps, bosses, etc.) positioned in some of the channels 1101. In particular, at least one of the example protrusions is positioned in and/or extends through an area of stagnation and/or a stagnation point associated with fluid in the block 1100, as described in connection with FIGS. 9 and 29. Accordingly, agglomeration and/or plugging associated with the fluid in the block 1100 is reduced and/or eliminated that would otherwise adversely affect the block 1100. Further, thermal efficiency of the block 1100 is improved by the protrusion(s) in the channels 1101. In some example, the channels 1101 and/or the protrusion(s) associated therewith may be shaped and/or sized to improve and/or maximize performance of the block 1100, as disclosed further below.

In the example of FIG. 13A, a first example wall (e.g., a corrugated wall) 1301 includes a first protrusion 1302 (e.g., a tab, a nub, a bump, a boss, etc.) and a second protrusion 1304 positioned on a first side 1306 thereof. In this example, the protrusions 1302, 1304, etc. associated with the first wall 1302 are positioned in non-adjacent channels 1101. Stated differently, the protrusions 1302, 1304, etc. associated with the first wall 1302 are positioned in a first channel (e.g., a peripheral channel) 1310 and a second channel (e.g., a peripheral channel) 1312 of the block 1100, but not a third channel (e.g., a central channel) 1314 positioned between the first channel 1310 and the second channel 1312.

In some examples, one or more of the protrusions 1302, 1304, etc. associated with the first wall 1301 extend entirely or partially through respective channels 1101. For example, the first protrusion 1302 and/or the second protrusion 1304 of FIG. 13A extend the length or a portion of the length of the first channel 1310.

As shown in FIG. 13A, a second side 1308 of the first wall 1206 does not have any protrusions. While FIG. 13A depicts only the first side 1306 of the first wall 1206 having the protrusions 1302, 1304, etc. associated therewith, in other examples, only the second side 1308 of the first wall 1206 includes protrusions. For example, as shown in the example of FIG. 13B, in contrast to the example of FIG. 13A, the first wall 1301 includes a third protrusion 1326 and a fourth protrusion 1328 positioned on the second side 1308 thereof instead of the first side 1306. Further, while FIGS. 13A and 13B depict the first wall 1301 having four protrusions, in other examples, the first wall 1206 may have fewer or additional protrusions.

In the example of FIGS. 13A and 13B, the protrusions 1302, 1304, 1326, 1328 etc. associated with the first wall 1301 are positioned offset relative to respective portions and/or surfaces of the first wall 1301. For example, the first wall 1301 of FIGS. 13A and 13B defines adjacent surfaces 1316, 1318 (i.e., a first surface 1316 and a second surface 1318), each of which has a respective protrusion 1302, 1304 positioned thereon offset relative to a central portion thereof.

In some examples, one or more of the protrusions 1302, 1304, 1326, 1328, etc. associated with the first wall 1301 extend a particular distance away from respective surfaces of the first wall 1301. For example, as shown in FIG. 13A, the first protrusion 1302 extends a first distance 1320 away from the first surface 1316 and the second protrusion 1304 extends a second distance 1322 away from the second surface 1318. Stated differently, the first protrusion 1302 has a first height and the second protrusion 1302 has a second height.

In some examples, a height of a protrusion is based on a wall thickness associated with a respective wall. For example, the first protrusion 1302 and/or the second protrusion 1304 of FIG. 13A are sized in accordance with a thickness (e.g., a nominal thickness “tₙₒₘᵢₙₐₗ”) 1324 associated with the first wall 1301. In some examples, each of the first height of the first protrusion 1302 and/or the second height of the second protrusion 1304 is less than about three times the thickness 1324.

Further, in some examples, one or more of the channels 1101 are shaped and/or sized based on a respective wall thickness associated therewith. For example, each of the first channel 1310, the second channel 1312, and/or the third channel 1314 includes a hydraulic diameter (e.g., “Dₕ”) related to the thickness 1324 of the first wall 1301. In such examples, a proportion between the hydraulic diameter and the thickness may be between about 1.1 to 70

$$( e . g . , 1.1 \leq \frac{{D}_{h}}{{t}_{nominal}} \leq 70 ) ,$$

which may facilitate manufacturing the block 1100.

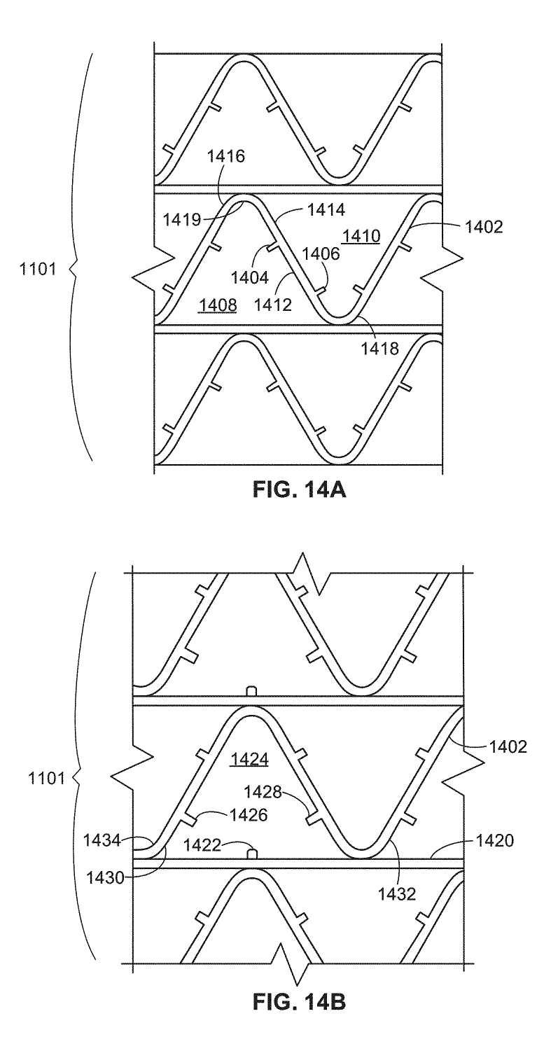

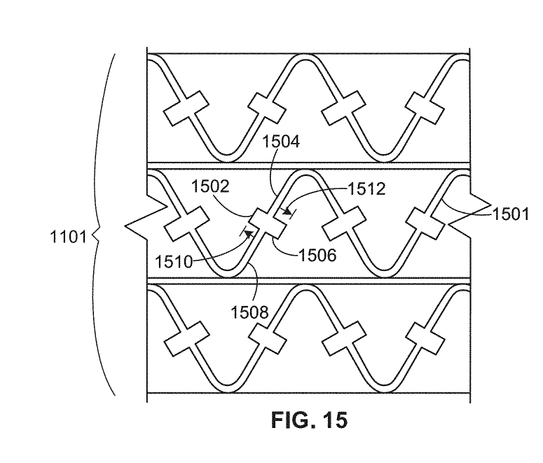

FIGS. 14A and 14B are views of the block 1100 of FIG. 11A viewed in a direction along axes of the channels 1101 and show example protrusions positioned in each of the channels 1101. In contrast to the examples of FIGS. 13A and 13B, the examples of FIGS. 14A and 14B include a first example wall (e.g., a corrugated wall) 1402 with adjacent protrusions disposed thereon in adjacent channels at least partially formed by the first wall 1402. As shown in FIG. 14A, a first protrusion 1404 and a second protrusion 1406 are positioned on the first wall 1402 in a first channel 1408 and a second channel 1410 respectively. In particular, the first protrusion 1404 is on a first side 1412 of the first wall 1402 and the second protrusion 1406 is on a second side 1414 of the first wall 1402 opposite the first side 1412.

In the example of FIG. 14A, each of the protrusions 1404, 1406, etc. associated with the first wall 1402 is positioned adjacent and/or proximate to respective folds and/or curves forming a corrugated shape of the first wall 1402. For example, the first protrusion 1404 of FIG. 14A is disposed adjacent a first portion (e.g., a folded and/or curved portion) 1416 of the first wall 1402. Similarly, the second protrusion 1406 of FIG. 14A is disposed adjacent a second portion (e.g., a folded and/or curved portion) 1418 of the first wall 1402 spaced from the first portion 1416.

In some examples, the first portion 1416 of the first wall 1402 faces at least partially toward the first protrusion 1404 and/or the second portion 1418 of the first wall 1402 at least partially faces toward the second protrusion 1406, as shown in FIG. 14A. For example, the first portion 1416 (and/or the second portion 1418) of the first wall 1402 has a concave side 1419 facing the first protrusion 1404 adjacent and/or proximate thereto. As shown in FIG. 14A, the concave side 1419 and the first protrusion 1404 are positioned on the same side 1412 of the first wall 1402. However, in other examples, the first portion 1416 and/or the second portion 1418 of the first wall1 1402 faces away from the respective protrusions 1426, 1428 (e.g., the concave side 1419 and the first protrusion 1404 are positioned on opposite sides 1412, 1414 of the first wall 1402), as disclosed further below in connection with FIG. 14B.

In the examples of FIGS. 14B and 14C, at least a second wall (e.g., a flat wall) 1420 includes one or more other protrusions (e.g., similar and/or different relative to the first protrusion 1404 and/or the second protrusion 1406) positioned thereon such that some of the channels 1101 have three protrusions therein while the other channels 1101 have only two protrusions therein. For example, as shown in FIG. 14B, the second wall 1420 includes a third protrusion 1422 positioned in a third channel 1424 along with a fourth protrusion 1426 and a fifth protrusion 1428. The number and design of protrusions can be by the manufacturing capabilities of the production house.

In the example of FIG. 14B, similar to the example of FIG. 14A, each of the protrusions 1426, 1428, etc. associated with the first wall 1402 is positioned adjacent and/or proximate to respective folds and/or curves forming a corrugated shape of the first wall 1402. For example, the fourth protrusion 1426 of FIG. 14B is disposed adjacent and/or proximate to a third portion (e.g., a folded and/or curved portion) 1430 of the first wall 1402. Similarly, the fifth protrusion 1428 of FIG. 14B is disposed adjacent and/or proximate to a fourth portion (e.g., a folded and/or curved portion) 1432 of the first wall 1402 spaced from the third portion 1430. However, in contrast to the example of FIG. 14A, a concave side 1434 of the third portion 1430 and the fourth protrusion 1426 adjacent and/or proximate thereto are positioned on opposite sides of the first wall 1402.

FIG. 15 is a view of the block 1100 of FIG. 11A viewed in a direction along axes of the channels 1101 and shows example protrusions positioned in each of the channels 1101. In the example of FIG. 15, a first example wall (e.g., a corrugated wall) 1501 includes a first protrusion 1502 positioned on a first side 1504 thereof and a second protrusion 1506 positioned on a second side 1508 thereof opposite the first side 1504. In particular, as shown in FIG. 15, the protrusions 1502, 1506 associated with the first wall 1501 are aligned to each other. In this example, each of the protrusions 1502, 1506 associated with the first wall 1501 is centrally disposed on the respective surfaces 1504, 1508 of the first wall 1501.

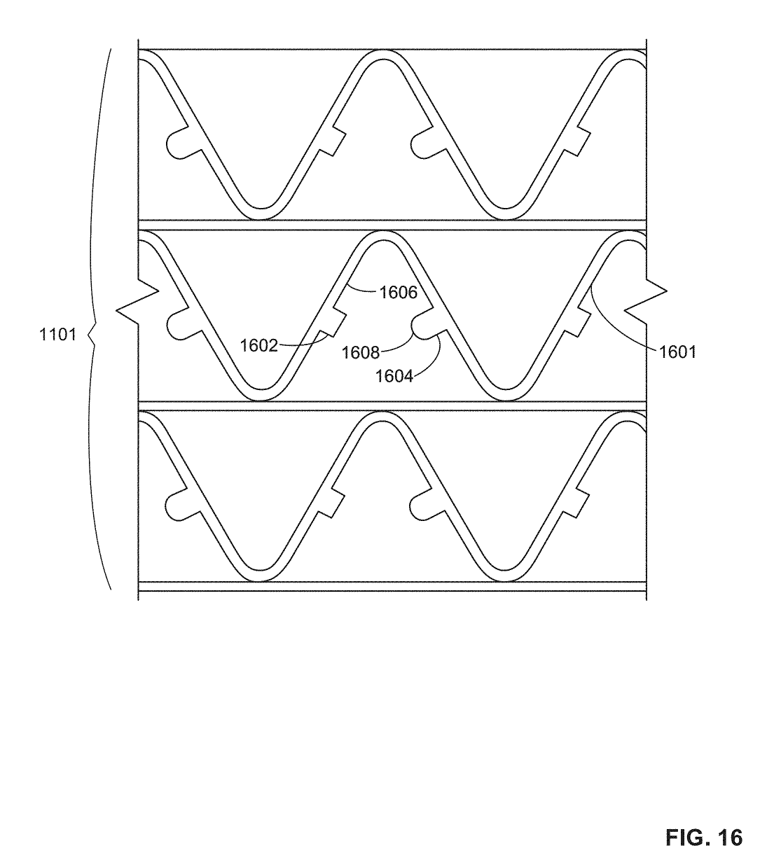

In the example of FIG. 15, the first protrusion 1502 has a first height different from a second height of the second protrusion 1506. Stated differently, the first protrusion 1502 extends away from its respective surface 1504 by a first distance 1510 and the second protrusion 1506 extends away from its respective surface 1508 by a second distance 1512. While FIG. 15 depicts the first distance 1510 to be less than the second distance 1512, in other examples, the first distance 1510 may be greater than or equal to the first distance 1512. Further, while FIG. 15 depicts each of the protrusions 1502, 1506, etc. associated with the first wall 1501 as substantially square, in other example, one or more of the protrusions 1502,1506, etc. may be shaped differently, as disclosed further below in connection with FIG. 16.

FIG. 16 is a view of the block 1100 of FIG. 11A viewed in a direction along axes of the channels 1101 and shows example protrusions positioned in some of the channels 1101. In particular, some of the protrusions of FIG. 16 have a first shape while the other protrusions have a second shape different from the first shape. For example, as shown in FIG. 16, a first example wall (e.g., a corrugated wall) 1601 includes a first protrusion 1602 and a second protrusion 1604 positioned on the same side 1606 thereof. The first protrusion 1602 of FIG. 16 is square, and the second protrusion 1604 of FIG. 16 is round and/or curved. More particularly, as shown in FIG. 16, the second protrusion 1604 includes a round and/or curved surface positioned at and/or formed by a distal end 1608 of the second protrusion 1604.

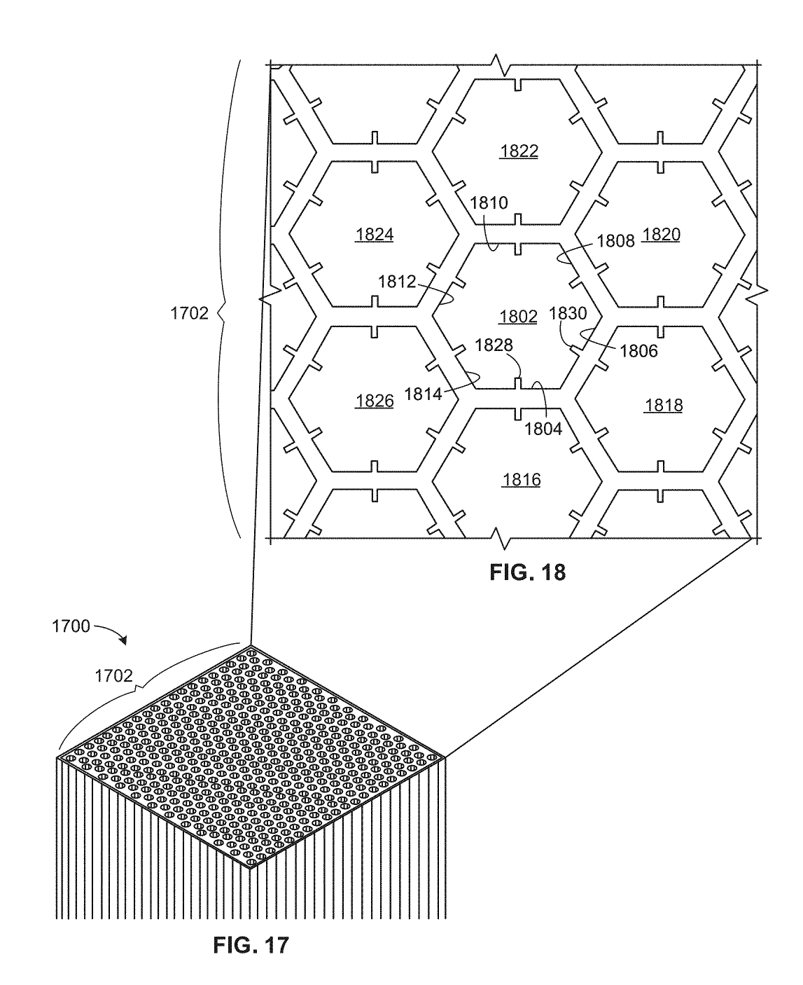

FIG. 17 is a view of an example block 1700 in which examples disclosed herein may be implemented. The block 1700 of FIG. 17 may correspond to any one or more of the previously disclosed blocks 102, 104, 200, 300, 400, 502, 504, or 1100. In particular, the block 1700 of FIG. 17 includes a cellular pattern (e.g., a polygon pattern) defined by a plurality of channels 1702 extending therethrough, as disclosed further below.

FIG. 18 is a view of the block 1700 of FIG. 17 viewed in a direction along axes of the channels 1702 and shows example protrusions positioned in each of the channels 1702. In particular, each channel 1702 of the cellular pattern is formed by peripheral walls. For example, a first or central channel 1802 is formed by a first wall 1804, a second wall 1806, a third wall 1808, a fourth wall 1810, a fifth wall 1812, and a sixth wall 1814, each of which are flat in this example. In this same manner, one or more peripheral channels surrounding the first channel 1802 are formed. For example, as shown in FIG. 18, the cellular pattern includes a second or peripheral channel 1816, a third or peripheral channel 1818, a fourth or peripheral channel 1820, a fifth or peripheral channel 1822, a sixth or peripheral channel 1824, and a seventh or peripheral channel 1826, each of which is adjacent the first channel 1802.

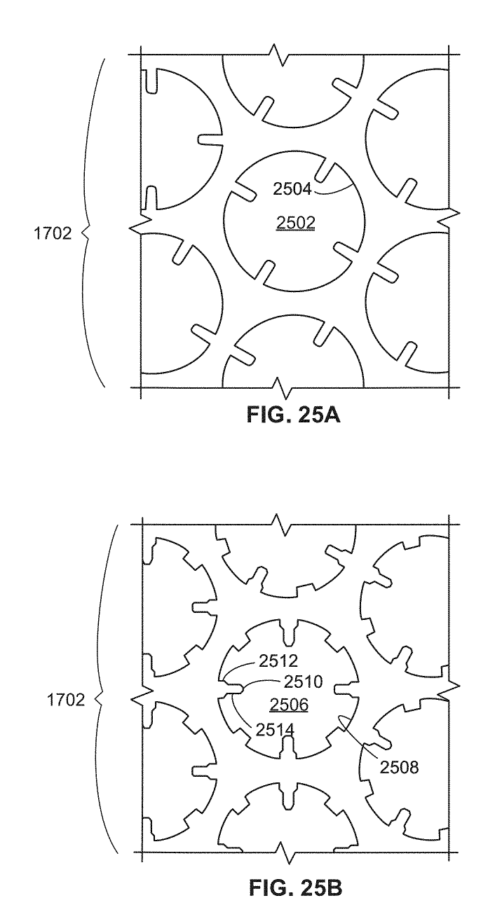

While FIG. 18 depicts each channel 1702 as having a hexagon shape, in other examples, one or more of the channels 1702 may have a different shape, such as an irregular and/or regular polygon shape (e.g., a triangle, a square, a rectangle, a pentagon, an octagon, etc.), and/or may be round and/or curved, as disclosed further below in connection with FIGS. 25A and 25B.

In the example of FIG. 18, each of the peripheral walls defining the channels 1702 includes a protrusion disposed thereon. For example, a first protrusion 1828 is centrally disposed on its respective wall 1804, a second protrusion 1830 is centrally disposed on its respective wall 1806, etc. While FIG. 18 depicts each of the peripheral walls having a protrusion centrally disposed thereon, in other examples, the protrusions may be positioned differently relative to the peripheral walls. For example, the first protrusion 1828 may be offset relative to a central portion of the first wall 1804, the second protrusion 1830 may be offset relative to a central portion of the second wall 1806, etc.

While the example of FIG. 18 depicts each of the channels 1802, 1816, 1818, 1820, 1822, 1824, 1826, etc. of the cellular pattern as having multiple protrusions therein, in other examples, at least some of the channels 1802, 1816, 1818, 1820, 1822, 1824, 1826, etc. of the cellular pattern have fewer (e.g., 0 or only 1) or additional protrusions therein. For example, the first channel 1802 may be provided with only the first protrusion 1828. Further still, while the example of FIG. 18 depicts each of the protrusions associated with the cellular pattern to be the same (e.g., having the same size and/or shape), in other examples, at least some of the protrusions may be different relative to the other protrusions, as disclosed further below.

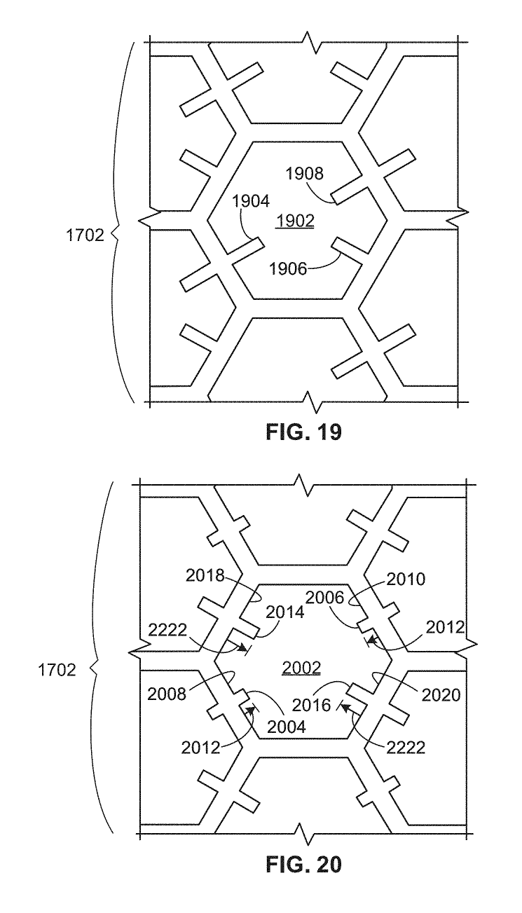

FIG. 19 is a view of the block 1700 of FIG. 17 viewed in a direction along axes of the channels 1702 and shows protrusions positioned in each of the channels 1702. In particular, the example protrusions of FIG. 19 are spaced asymmetrically in each channel relative to a respective axis of the channel. For example, a first channel (e.g., a central or peripheral channel) 1902 of the cellular pattern includes a first protrusion 1904, a second protrusion 1906, and third protrusion 1908 disposed therein. As shown in the example of FIG. 19, the protrusions 1902, 1904, 1906 are spaced and/or distributed asymmetrically relative to a central axis of the first channel 1902. While each of the protrusions 1902, 1904, 1906 associated with the first channel 1902 are sized and/or shaped the same relative to each other, in other examples, at least one of the protrusions 1902, 1904, 1906 may be sized and/or shaped differently relative to one another.

FIG. 20 is a view of the block 1700 of FIG. 17 viewed in a direction along axes of the channels 1702 and shows protrusions positioned in each of the channels 1702. In the example of FIG. 20, unlike the examples of FIGS. 18 and 19, some of the protrusions have a first size while the other protrusions have a second size different from the first size. For example, a first channel (e.g., a central or peripheral channel) 2002 of the cellular pattern includes a first protrusion 2004 and a second protrusion 2006 disposed therein, each of which has a first height and/or extends away from a respective peripheral wall 2008, 2010 by a first distance 2012. Further, the first channel 2002 also includes a third protrusion 2014 and a fourth protrusion 2016 disposed therein, each of which has a second height different from (e.g., less than) the first height and/or extends away from a respective peripheral wall 2018, 2020 by a second distance 2222 different from (e.g., less than) the first distance 2012.

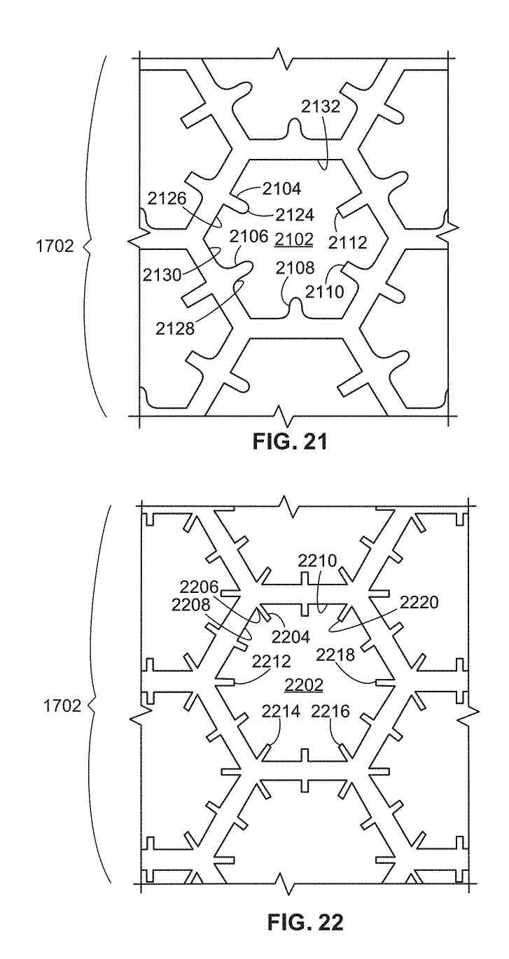

FIG. 21 is a view of the block 1700 of FIG. 17 viewed in a direction along axes of the channels 1702 and shows protrusions positioned in each of the channels 1702. In the example of FIG. 21, some of the protrusions have a first shape while the other protrusions have a second shape different from the first shape. For example, a first channel (e.g., a central or peripheral channel) 2102 of the cellular pattern includes a first protrusion 2104, a second protrusion 2106, a third protrusion 2108, a fourth protrusion 2110, and a fifth protrusion 2112 disposed therein, each of which has a unique size and/or shape relative to the others.

In the example of FIG. 21, the first protrusion 2104 of FIG. 21 includes a distal end 2124 having a round and/or curved surface. Further, the first protrusion 2104 of FIG. 21 does not form a round and/or curved surface together with its respective wall 2126. In some examples, unlike the first protrusion 2104, the second protrusion 2106 (and/or one or both of the third protrusion 2108 or the fourth protrusion 2110) of FIG. 21 forms a round and/or curved surface (e.g., a fillet) 2128 with its respective wall 2130, as shown in FIG. 21. Additionally or alternatively, in the example of FIG. 21, at least one wall 2132 providing the first channel 2102 does not have any protrusions thereon.

FIG. 22 is a view of the block 1700 of FIG. 17 viewed in a direction along axes of the channels 1702 and shows protrusions positioned in each of the channels 1702. In the example of FIG. 22, one or more of the channels 1702 of the cellular pattern include at least one corner protrusion. For example, a first channel (e.g., a central or peripheral channel) 2202 of the cellular pattern includes a first corner protrusion 2204 positioned at an intersection point 2206 between adjacent peripheral walls 2208, 2210. Stated differently, the first corner protrusion 2204 is formed by the first wall 2208 and the second wall 2210. In this same manner, the first channel 2202 of FIG. 22 includes a second corner protrusion 2212 adjacent the first corner protrusion 2204, a third corner protrusion 2214, a fourth corner protrusion 2216, a fifth corner protrusion 2218, and a sixth corner protrusion 2220 adjacent the first corner protrusion 2204. While the example of FIG. 22 depicts the six corner protrusions 2012, 2016, 2018, 2020 in the first channel 2202, in other examples, the first channel 2202 (and/or one or more of the other channels 1702) may include fewer (e.g., only 1) or additional corner protrusions.

FIGS. 23A and 23B are views of the block 1700 of FIG. 17 viewed in a direction along axes of the channels 1702 and show protrusions positioned in each of the channels 1702. In particular, similar to the example of FIG. 22, each of the channels 1702 includes at least one corner protrusion therein. More particularly, in the example of FIGS. 23A and 23B, some of the protrusions (e.g., corner protrusions) are shaped and/or sized differently relative to the other protrusions (e.g., non-corner protrusions). For example, as shown in FIG. 23A, a first channel (e.g., a central or peripheral channel) 2302 of the cellular pattern includes a first corner protrusion 2304 positioned at an intersection point 2306 between adjacent walls 2308, 2310 and a first protrusion 2312 adjacent thereto (e.g., centered and/or centrally disposed on the respective wall 2308).

In the example of FIG. 23A, the first corner protrusion 2304 and the first protrusion 2312 are sized differently relative to each other. For example, the first corner protrusion 2304 is wider and/or thicker than the first protrusion 2312. Stated differently, the first corner protrusion 2304 has a thickness greater than a thickness of the first protrusion 2312. Additionally or alternatively, in some examples, the first corner protrusion 2304 is shorter than the first protrusion 2312. Stated differently, the first corner protrusion 2304 has a height less than a height of the first protrusion 2312. Further, as shown in FIG. 23A, the first corner protrusion 2304 is round and/or curved, and the first protrusions 2312 is square. While FIG. 23A depicts the first corner protrusion 2304 as being shorter than the first protrusion 2312, in other examples, the first corner protrusion 2304 may be taller than the first protrusion 2312, as disclosed further below in connection with FIG. 23B.

In the example of FIG. 23B, a second channel 2302 of the cellular pattern includes a second corner protrusion 2314 positioned at an intersection point 2316 between adjacent walls 2318, 2320 and a second protrusion 2322 adjacent thereto (e.g., centered and/or centrally disposed on the respective wall 2320). In particular, the second corner protrusion 2314 of FIG. 23B includes a height greater than a height of the second protrusion 2322.

FIGS. 24A and 24B are views of the block 1700 of FIG. 17 viewed in a direction along axes of the channels 1702 and shows protrusions positioned in each of the channels 1702. In the example of FIGS. 24A and 24B, at least some (e.g., all) of the protrusions have ramped and/or inclined surfaces. For example, as shown in FIG. 24A, a first channel (e.g., a central or peripheral channel) 2402 of the cellular pattern includes a first protrusion 2404 positioned on a respective peripheral wall 2406. In particular, the first protrusion 2404 has a tapered shape formed by adjacent surfaces 2408, 2410 thereof. In some examples, the surfaces 2408, 2410 of FIG. 24A are flat and/or angled relative to each other. For example, an angle formed by a first plane defining the first surface 2408 and a second plane defining the second surface 2410 is between about 80 degrees to 100 degrees. However, in other examples, the angled formed by the first surface 2408 and the second surface 2410 may be less than 80 degrees or greater than 100 degrees, as disclosed further below in connection with FIG. 24B. Additionally or alternatively, in some example, the first surface 2408 and/or the second surface 2410 are round and/or curved.

In the example of FIG. 24B, a second channel (e.g., a central or peripheral channel) 2412 of the cellular pattern includes a second protrusion 2414 positioned on a respective wall 2416. In particular, second protrusion 2414 is cone-shaped and also taller and narrower than relative to the protrusion 2404 of FIG. 24A.

FIGS. 25A and 25B are views of the block 1700 of FIG. 17 viewed in a direction along axes of the channels 1702 and shows protrusions positioned in each of the channels 1702. In the example of FIGS. 25A and 25B, one or more (e.g., all) of the channels 1702 are formed by round and/or curved peripheral walls. For example, as shown in FIGS. 25A and 25B, a first channel (e.g., a central or peripheral channel) 2502 (FIG. 25A) of the cellular pattern is formed by a first round and/or curved wall (e.g., an annular wall) 2504, and a second channel 2506 (FIG. 25B) of the cellular pattern is formed by a second round and/or curved wall (e.g., an annular wall) 2508. While the examples of FIGS. 25A and 25B depict the first and second walls 2504, 2508 to be substantially circular, in other examples, the first wall 2504 and/or the second wall 2508 may be shaped differently. In some examples, the first wall 2504 and/or the second wall 2508 are oval shaped, ellipse shaped, etc.

In the example of FIG. 25B, one or more protrusions associated with the channels 1702 are segmented and/or have differently shaped portions. For example, the second channel 2506 of FIG. 25B includes a first protrusion 2510 therein having multiple segments and/or portions. In some examples, the first protrusion 2510 includes a first portion 2512 positioned on the second wall 2508 and a second portion 2514 extending away from the first portion 2512 toward a central portion of the second channel 2506, as shown in FIG. 24B. The first portion 2512 of the first protrusion 2510 of FIG. 24B is ramped and the second portion 2514 has a constant width or thickness.

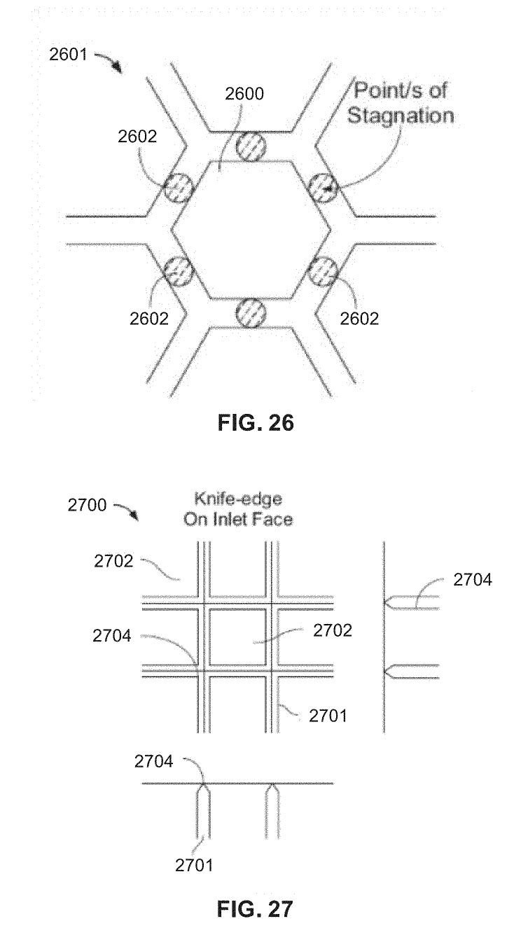

FIG. 26 is an enlarged cross-sectional view of a channel 2600 of a block 2601 with points of stagnation 2602. These points 2602 intersect with the incoming flow where the concentration of growth particles is the highest.

FIG. 27 depicts views of a block 2700 illustrating possible modifications to walls 2701 surrounding square channels 2702 at the inlet and/or outlet walls of the block 2700. A secondary manufacturing operation may be used to form substantially sharp (e.g., knife-like) tapered edges 2704 to resist particle growth (e.g., decrease agglomeration). Although the block 2700 is depicted as having a square channel geometry, any other appropriate geometry may be used with the sharp tapered edges 2704. Additionally or alternatively, the substantially sharp tapered edges 2704 could be manufactured into the block 2700 in a single step (e.g., during a stamping process, etc.).

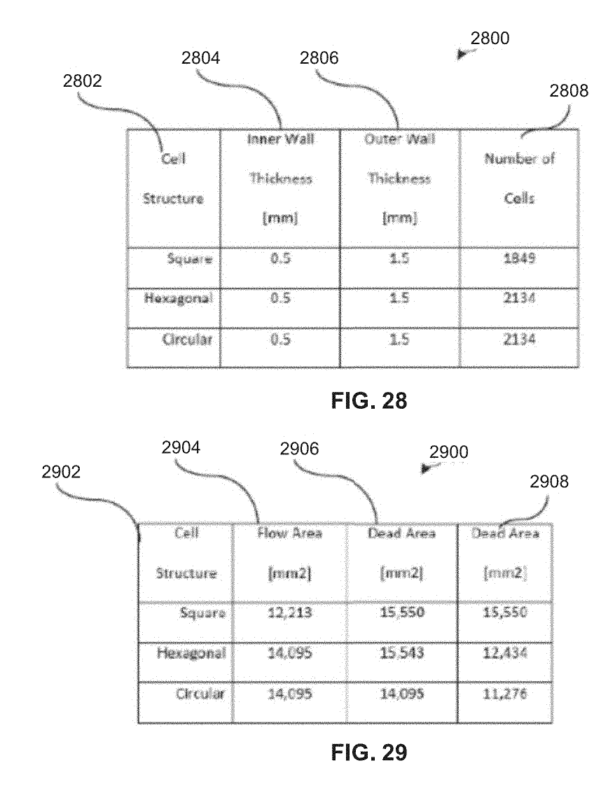

FIG. 28 is a table 2800 representing the production capable design parameters found within an example block 2801 (not shown) with a width (X and Y) of 150 mm. A column 2802 represents the channel geometry. A column 3104 represents inner wall thicknesses of the block 2801. A column 2806 represents outer wall thickness of the block 2801 and a column 2808 represents the number of channels that may be placed within the block 2801 based on the shape of the channels shown in the column 2802. The square channel structures result in the least number of channels being placed into the block 2801.

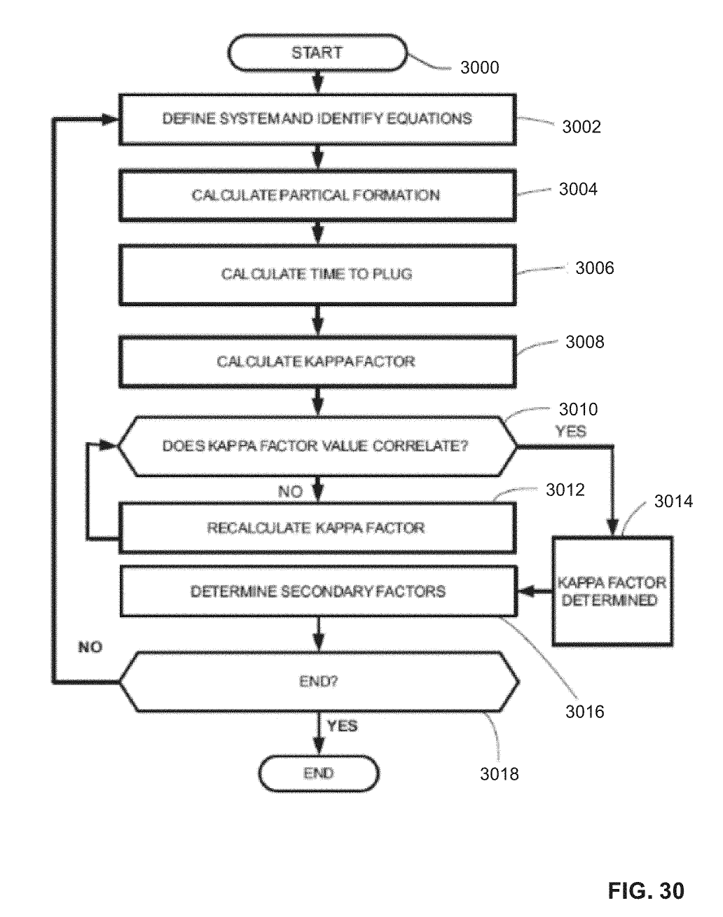

FIG. 29 is a table 2900 representing resultant block data for system performance of the block 2801 of FIG. 28. A column 2902 represents the channel geometry. A column 2904 represents the corresponding flow area, a column 2906 represents a dead area of the corresponding geometry (i.e., the total cross-sectional area of all the openings in the block 2801), and a column 2908 represents a thermal effectiveness cross-sectional area (i.e., the portion of the total cross-sectional area of column 2906 taking into account an efficiency effect resulting in an effective area for transferring the heat). Combining equation 12, which will be discussed later in connection with FIG. 30, and the results of table 2900, the pressure drop of the hexagon and the circular structure is relatively greater than the square structure. However, the DRE of the square channel geometry is less than that of the hexagon or the circular geometry.

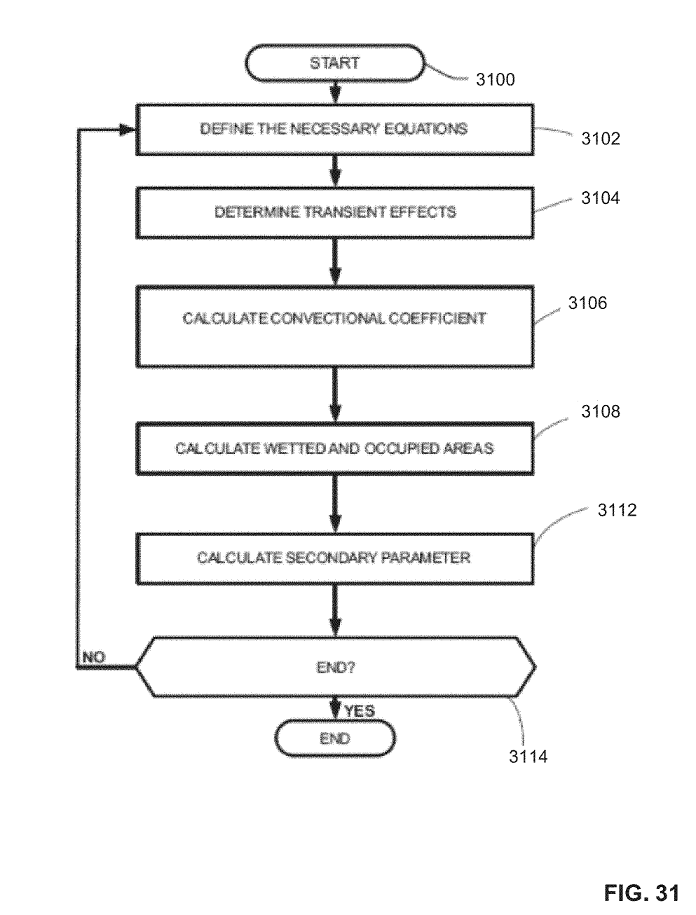

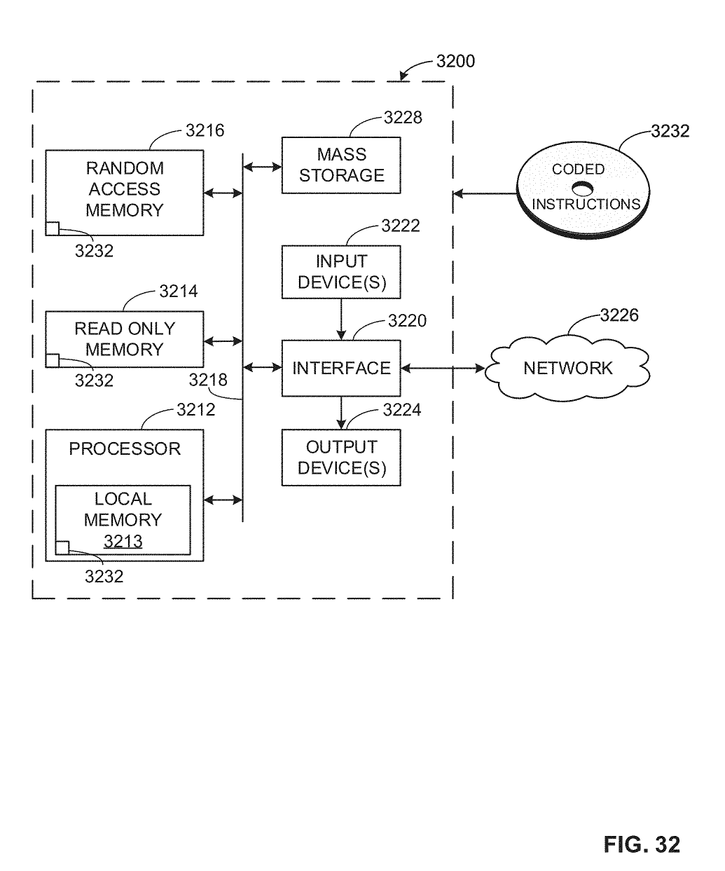

Flowcharts of representative example machine readable instructions for calculating relevant parameter values for both plug resistance and thermal efficiency are shown in FIGS. 30 and 31. In each example, the machine readable instructions comprise a program for execution by a processor such as the processor 3212 shown in the example processor platform 3200 discussed below in connection with FIG. 32. The program may be embodied in software stored on a tangible computer readable storage medium such as a CD-ROM, a floppy disk, a hard drive, a digital versatile disk (DVD), a Blu-ray disk, or a memory associated with the processor 3212, but the entire program and/or parts thereof could alternatively be executed by a device other than the processor 3212 and/or embodied in firmware or dedicated hardware. Further, although the example program is described with reference to the flowchart illustrated in FIG. 30 or 31, many other methods of implementing the calculations may alternatively be used. For example, the order of execution of the blocks may be changed, and/or some of the blocks described may be changed, eliminated, or combined.

As mentioned above, the example processes of FIGS. 30 and 31. may be implemented using coded instructions (e.g., computer and/or machine readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and transmission media. As used herein, “tangible computer readable storage medium” and “tangible machine readable storage medium” are used interchangeably. Additionally or alternatively, the example processes of FIGS. 30 and 31 may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable, storage device and/or storage disc and to exclude propagating signals and transmission media. As used herein, when the phrase “at least” is used as the transition term in a preamble of a claim, it is open-ended in the same manner as the term “comprising” is open ended.

FIG. 30 is a flowchart depicting an example process that may be implemented to calculate relevant parameter values for plug resistance. At the onset of this analysis, plug resistance is the main concern of this example (block 3000). However, increasing plug resistance is not necessarily exclusive of the method to increase thermal efficiency described in connection with FIG. 31 (i.e., there may be overlap in the results brought about by the analyses provided in both example processes). The plug resistance goal corresponds with secondary requirements of flow stagnation and a pressure differential. A first step in this analysis involves defining the system and identifying the relevant equations (block 3002). In this example, a pollutant flow heavily laden with silicon oxidizes within a combustion chamber and precipitates silicon dioxide, SiO₂. The average flow velocity through the cold-face (zone 111) is

$$1.5 \frac{m}{s} .$$

The silicon mass flow rate is

$$0.1 \frac{kg}{hr}$$

or contains a chamber concentration of

$$0.9 \frac{kg}{{m}^{3} hr} .$$

The residence time (e.g., a time a molecule stays in or travels through a reaction zone) is 1.5 seconds at a temperature of 850° C.

A second step involves calculating particle formation (block 3004). Utilizing theoretical particle formations and the Buckingham-Pi theorem with respect to aerosol dynamics provides a basis for estimating a time to clog/plug a system. The area of stagnation and the number of stagnation points are critical to determining the time to plug. Equations 8, 9 and 11 may be used to find a channel structure which will perform within predefined system parameters. These calculations demonstrate that substantially thin walls and relatively higher flow areas prevent particle growth. This is mainly due to the thermal dynamic loads which are present within the flow. In some examples, the inner wall thickness may be limited to approximately 0. 0.085 mm. Presuming this value as a limiting factor, the outer wall and hydraulic diameters may be defined with respect to a particular system. Additionally, particle growth is related to temperature. Within the system requirements as set forth above, a 30% reduction in temperature may correspond to a 10% reduction in particle size, which may be sufficient to resist plugging for a system. The hexagonal or circular channel structure may cool a fluid faster, thereby increasing its resistance to plugging. For an improved design block, a 30% reduction in temperature should occur within the first 300 mm of the portions 120, 124 (e.g., zones 3 & 4) of FIG. 1B.

Equation 1 is commonly referred to as system efficiency or effectiveness. T_{Comb} is a combustion chamber temperature. Tᵢₙₗₑₜ is a temperature at an inlet to the oxidizer. Tₒᵤₜₗₑₜ is a temperature at an outlet of the oxidizer.

$$ɛ = \frac{{E}_{Out}}{{E}_{In}} = \frac{{T}_{Comb} - {T}_{Outlet}}{{T}_{Comb} - {T}_{Inlet}} \qquad ( 1 )$$

Equation 2 is a theoretical initiation of plugging at the state at which a system fails to operate in a nominal state. The flow is considered to be choked when the flow is less than 50-100% of its nominal design flow: Equation 2 has a 50% choke factor. Q_{Nominal} is a nominal design flow. \dot{m} is a mass flow rate. ρ is an average stream density.

$$Choke \text{/} Plug ≡ {Q}_{Nominal} < \frac{{Q}_{Nominal}}{2} \\ {Q}_{Nominal} = \dot{m} ρ {U}_{Ave} \qquad ( 2 )$$

For equation 3, U_{Ave} is an average stream velocity where N_{cells} is a number of channels where the channel is circular.

$${U}_{Ave} = \frac{{Q}_{Nominal}}{{N}_{Cells} \frac{π}{4} {D}_{h}^{2}} \qquad ( 3 )$$

Equation 4 calculates a hydraulic diameter, Dₕ. The hydraulic diameter is used often in relation to pipe or duct flow where a Reynolds—Dₕ, which is the Reynolds number with respect to the hydraulic diameter, is calculated. Its geometric equivalence is based upon flow through a tube or circular cross-section. Area_{Cross-section} is a cross-sectional open area. Perimeter_{Wetted} is a periphery of the channel which is exposed to the flow.

$${D}_{h} = \frac{4 ( {Area}_{Cross - section} )}{{Perimeter}_{Wetted}} ≎ {\overline{D}}_{h} = \sqrt{\frac{4 ( {Area}_{flow} )}{π}} \qquad ( 4 )$$

Equation 5 represents a basic form of particle diffusivity, where E

$${E}_{a} [ \frac{J}{mol} ]$$

is an activation energy, P is a pressure [Pa], and

$${V}_{a} [ \frac{{cm}^{3}}{mol} ]$$

is an activation volume for diffusion. The exponential is dependent on pressure and temperature as seen in this equation.

$${D}_{f} = {D}_{o} {e}^{\frac{- {E}_{a} - {PV}_{a}}{kT}} \qquad ( 5 )$$

Equation 6 represents a basic form of coalescence on the atomic scale, where vₚ is a particle volume, σ is a surface tension, D_{f} is a solid state diffusivity, and vₒ is a volume of diffusing species.

$${τ}_{c} = \frac{3 {kTv}_{p}}{64 π {D}_{f} σ {v}_{o}} \qquad ( 6 )$$

Equation 7 represents a pressure difference a nanoparticle would experience from the Laplace equations. σ is the surface tension, dₚ is a particle diameter, Pᵢ is an internal pressure of the particle, and Pₐ is an ambient pressure of the particle.

$${P}_{i} - {P}_{a} = \frac{4 σ}{{d}_{p}} \qquad ( 7 )$$

Combining equations 5, 6 and 7, a general form for the time of coalescence is obtained. Equation 8 is a basis for particle growth/formation. dₚ is the particle diameter [m]. kₒ is an oxygen to saline molar ratio

$$[ \frac{J}{mol K} ] .$$

T is the atmospheric temperature [K]. Dₒ is an area of aerosol diffusivity constant

$$[ \frac{{cm}^{2}}{s} ] .$$

vₒ is the volume based on oxygen [cm³]. λ is a volume of the oxygen anion [cm³]. σ is the surface tension

$$[ \frac{J}{{m}^{2}} ] .$$

Eₐ is the activation energy

$$[ \frac{J}{molecule} ] .$$

Vₐ is the molar volume

$$[ \frac{{cm}^{3}}{mol} ] .$$

Pₐ is the atmospheric pressure. There are various values for λ and kₒ, depending on the source as well as the activation energies with respect to the reactions that are taking place. From an analysis in this example, the time to coalesce for a particle size of 0.03 nm is 1.5 s, which means that within the system cycle time, a particle may form within the stream with an average diameter of 0.03 nm. This data suggests that a typical oxidizer will have enough residence time to propagate particle growth. After the particle coalesces, it will grow exponentially. The coalescent points correlate to the points of stagnation seen in FIG. 26. Combining linear interpolation with the QRRK theory without taking the area of stagnation or dynamic forces into account, at tᵢ=0.5 s and t_{f}=1.5 s, a channel with an average width of 1.9 mm would take approximately one day to plug.

$${τ}_{c} = \frac{{d}_{p}^{3} {k}_{o} T}{128 {D}_{o} λσ {v}_{o}} {e}^{[ \frac{{E}_{a} + {V}_{a} ( {P}_{a} + \frac{4 σ}{{d}_{p}} )}{{k}_{o} T} ]} \qquad ( 8 )$$

Equation 9 represents an area of stagnation, A_{Stag}, which is directly related to a total area, A_{Total}, occupied by the channel/structure and an area, A_{Hyd}, of the flow moving through the channel.

A_{Stag}=A_{Total}−A_{Hyd} (9)

Equation 10 represents an average length from the edge of the hydraulic flow to the line of stagnation. This value will vary with different designs. Mathematical arrangement optimization favors an arrangement of a circle touching six sides. This arrangement corresponds to a circular structure which has six points of contact.

$${\overline{L}}_{Stag} = \frac{1}{b - a} {\int }_{a}^{b} y ( x ) dx \qquad ( 10 )$$

A third step involves calculating a time to plug (block 3006). Equation 11 represents one form to estimate the time to plug for a system. k is a system correlation factor for mapping prior data to plugging. P_{Stag} is a value for the points of stagnation. ρₐᵢᵣ is a density of air. μ is a dynamic viscosity of the air. V is a combustion bed velocity. tᵣ is a residence time. ρ_{Si} is a density of the silicon in the chamber. In order for this equation to be valid, A_{Stag} must be less than A_{hydraulic}.

$${\overline{t}}_{Plug} = κ \frac{π {D}_{h}^{2}}{4 {A}_{Stag}} ( \frac{{ρ}_{Air}}{μ} {V}^{2} ) {e}^{\frac{- 100 {t}_{r}^{2} {ρ}_{Si}}{{κP}_{Stag} {ρ}_{Air}}} \qquad ( 11 )$$

For an example where k=30 s², L(square)=0.48 mm, L(hex)=0.34 mm, L(circle)=0.34 mm, A_{stag}(square)=3.15 mm², A_{stag} (hex)=2.73 mm², A_{stag}(cir)=2.73 mm², Dₕ=2.9 mm, inner wall thickness=0.5 mm, P_{Stag}(square)=⁴, P_{Stag} (hex)=6, P_{Stag} (circular scenario 1)=8, P_{Stag} (circular scenario 2)=5, the dynamic factor

$$( \frac{ρ {V}^{2}}{m} ) = 0.221 \frac{{10}^{6}}{s} ,$$

with Lₐᵥₑ for the circle=0.385 mm and Lₐᵥₑ for the others=0.5 mm, the time to plugging for the square structure is 5.2 months. The time to plugging for the hexagonal structure, the circular scenario 1, and the circular scenario 2 are 6.0, 6.1 and 5.98 months respectively

The octagonal structure may resist plugging for a longer period of time than the hexagonal structure and may also have increased heat transfer to the stream. Manufacturing costs for the octagonal structure may be greater than the hexagonal block. However, the octagonal block may still be the preferred structure. A factor, referred to as an infinity-clause, may cause the circular structure to fail earlier than the hexagonal structure, as seen in the circular scenario 2. When the side of the polygon is on the order of the inner wall thickness, then the infinity clause will apply if the pollutant concentration is above system tolerable levels. This condition would promote particle growth at an infinite number of points, each with an exponential growth rate.

Equation 11 illustrates that the square structure may plug relatively earlier than the hexagonal or the circular structures. Some circular structures may clog in a relatively shorter time period in comparison to the hexagonal structure because there is an infinite set of unions between a perimeter of the circle and a boundary layer of the flow. If the dynamic loads are sufficient and the infinity clause is out of scope, the circular structure in the scenario 1 will remain free from plugging for the largest amount of time. Blocks 3008, 3010, 3012, 3014 illustrate how the k factor of equation 11 must be solved reiteratively.

A fourth step involves calculating secondary parameters (block 3016). The secondary parameters include thermal convection, flow stagnation, pressure differential and/or destruction removal efficiency (DRE). Should the length or area of stagnation, from equation 10 be too large, some or all of the secondary parameters may have less-favorable values. The closer L_{stag} is to the initial particle size, the longer the system will perform without being plugged. Reducing the inner wall thickness will decrease the pressure differentials and the area of stagnation. If the process tools and the manufacturing process to make the block are designed correctly, the DRE may also be reduced. The average length of stagnation may be related to the inner wall thickness which, in turn, may be related to the hydraulic diameter. The ratio between the inner wall and the hydraulic diameter affects the pressure losses of the system.

The pressure differentials may be calculated using Bernoulli's equation 12. A balance between the pressure losses and the thermal conductivity may be realized, in part, with equation 24.

$$\frac{\partial ψ}{\partial t} + \frac{{u}^{2}}{2} + \frac{P}{ρ} + gz = f ( t ) \qquad ( 12 )$$

Utilizing current production technology, example design parameters will be similar to those displayed in the table 2900 of FIG. 29. These example design parameters will yield the values shown in the table 2900 of FIG. 29. As seen in the table 2900 of FIG. 29 and utilizing equation 12 in a steady state, the pressure drop would be reduced with respect to the baseline example of FIG. 6 in either of the preferred designs because the flow area is greater. Equating similar system efficiencies, the DRE would also be less with the hexagonal or the circular structure.

Other structural modifications such as, but not limited to, those shown and described in connection with FIGS. 2, 5, 10D, 11A, 11B, 12, 13A, 13B, 14A, 14B, 15-22, 23A, 23B, 24A, 24B, 25A, 25B, 26, and 27 may also be employed to improve plug resistance. As mentioned above, the kappa factor, k, in equation 11 is found by iteration (blocks 3008-3014). This factor is system dependent and will vary with respect to system process variables, such as temperature, pressure, particulate concentration and other variables.

The factors, ratios and structural designs are dependent on system parameters and/or current production capabilities. Additional factors to consider are the cost of manufacturing and production-house capabilities. Material and die costs, etc. may benefit one type of structure over another. Taking these factors into account, the hexagonal structure may be the preferred design. Hence, the plurality of channel structures would be hexagonal in appearance. The block structure, in this example, satisfies resistance to plugging, and reduces both the DRE and the pressure drop. Once these factors and the results are determined, it may be determined whether or not to proceed to another analysis with new parameters and/or variables (block 3318).

FIG. 31 is another flowchart depicting another example process that may be implemented to calculate relevant values for the goal of improved thermal efficiency (block 3100). System efficiency is the primary goal of this example or system requirement. As mentioned with FIG. 30, the goals and results of this analysis are not necessarily exclusive of the goal of plug resistance (e.g., both analyses may have an overlap of results).

The dichotomy of the system complexities is exemplified by equation 5. In order to improve the efficiency of the system, the energy out, Eₒᵤₜ, must be maximized, while the systems total energy, Eᵢₙ, is minimized. In either case, the heat transfer from the media to the air stream is crucial. For example, if there was no heat transferred between the media and the airstream, a burner would have to compensate to heat the stream up to the desired temperature. Thus, maximizing the energy that goes in and out of the stream will allow less use of the burner and, therefore, increase system efficiency. Based on these considerations, first the set of equations is defined (block 3102).

Equation 13 represents the energy contained within the air stream including energy transferred to and from a block.

q̅_{Air}=\dot{m}_{Air}Cₚ(T_{Air}−T_{∞}) (13)

Equation 14 represents the energy in a block. Note that when the block temperature reaches the air temperature, no energy is transferred. A hot combustion zone around 900° C. will affect the top 750 mm of the block with a nominal thermal conductivity value of approximately 2

$$\frac{W}{m K}$$

and a cycle time of 60 s. This implies that the heat available to the stream will be relatively consistent with respect to the chamber temperature within the top 600 mm of the block.

q̅_{Block}=k_{Block}L(T_{Air}−T_{Block}) (14)

Equation 15 represents the heat transfer to or from a block. The average transfer of energy to or from the block is calculated by an average thermal convection coefficient, a surface area of “contact,” a block temperature and a fluid temperature. The surface area of contact, A_{Surf}, is the actual wetted surface area.

q̅_{Trans}=h_{Ave}A_{Surf}(T_{wall}−T_{Fluid}) (15)

Though there are many scenarios in which the energy into the air may be maximized, this example will focus on the mass of the block. This example will consider a cycle time of 60 s, and a Dₕ of 2.9 mm with walls 0.5 mm in average thickness. For this example, the bed heights will be 1.2 and 1.5 m. The initial conditions may assist in defining the average values for the system operational conditions. The block design may be adjusted depending upon system and/or operational considerations. This example will consider three channel morphologies including the square, the hexagon, and the circle.

Equation 16, the simplified transient thermal convective heat transfer equation, demonstrates that as the cycle time increases, more heat is taken or given to the source, which results in lower system efficiency (block 3104). Due to the difficulties in solving this equation, this example will consider simplistic approximations for optimization.

$${∇}^{2} T + \frac{\dot{q}}{k} = \frac{ρ {c}_{p}}{k} \frac{\partial T}{\partial t} \qquad ( 16 )$$

Next, the steady-state thermal convective coefficient, h̅, must be calculated (block 3106). Equation 17 represents the actual thermal convective heat transfer equation to solve for a typical oxidization system. Note that the constant heat flux scenario described below is not usually present in the typical thermal oxidizer where the constant heat source is the burner. However, this equation is useful in a simplistic comparison of various designs.

$$\overline{h} = \frac{1}{4} \frac{{c}_{a} {Nuk}_{f}}{l \sqrt{1 - {ρ}_{Cell}}} ( 1 - \frac{{c}_{n} {c}_{w} t}{l} + 2 {c}_{n} n \sqrt{\frac{2 {k}_{s} t \sqrt{1 - {ρ}_{Cell}}}{{c}_{a} {Nuk}_{f} l}} Tanh [ \frac{{c}_{H} H}{2 l} \sqrt{\frac{{c}_{a} {Nuk}_{f} l}{2 {k}_{s} t \sqrt{1 - {ρ}_{Cell}}}} ] ) \qquad ( 17 )$$

The average thermal convection coefficient contains channel morphology factors including Cₐ, cₙ, c_{w}, N, l, and ρ_{Cell}. It is also dependent on Nussult's number, Nu, and the thermal conductivity of the fluid and the solid. Solving this equation for the three channel morphologies, demonstrates that the circular structure will have the highest heat transfer. Since the bed height is greater than 0.6 m and the heat transfer is greater, the block will transfer more heat to or from the stream. This transfer of heat reduces the outlet temperature, thereby increasing the overall system efficiency. A well-arranged circular channel structure will also have more mass.

A next step involves calculating wetted and occupied areas for the channels (block 3108). Equations 18, 19 and 20 represent the calculations for determining the wetted area of a channel structure with respect to the hydraulic diameter. The wetted area is the surface area of the channel (i.e., the total open area).

$$\begin{matrix}{A}_{Wetted Square} = {D}_{h}^{2} & ( 18 ) \\ {A}_{Wetted Hex} = \frac{\sqrt{3}}{2} {D}_{h}^{2} & ( 19 ) \\ {A}_{Wetted Cir} = \frac{π}{4} {D}_{h}^{2} & ( 20 )\end{matrix}$$

Equations 21, 22 and 23 represent the area the channel structure occupies with respect to the hydraulic diameter (e.g., the occupied area of the channel).

$$\begin{matrix}{A}_{Occupied Square} = {( {D}_{h} + t )}^{2} & ( 21 ) \\ {A}_{Occupied Hex} = \frac{\sqrt{3}}{2} {( {D}_{h} + t )}^{2} & ( 22 ) \\ {A}_{Occupied Cir} = \frac{\sqrt{3}}{2} {( {D}_{h} + t )}^{2} & ( 23 )\end{matrix}$$

A highly efficient arrangement for circular channel structures is one that touches on six sides, hence, the occupied area of the circular structure is substantially similar to the hexagon structure. Using these equations with optimal arrangements, the circular structure will have 8.1% more mass than the square structure and 24.8% more than the hexagon structure. This does not, however, take into account the differing number of channels for each geometry. In any case, the circular channel structure will have the most mass, the highest thermal convection coefficient and, thus, a well-arranged circular structure may have the largest system efficiency.

Among the several caveats in generating an optimal block design, the spacing between the channels and their orientation are among the most important. The time dependent equations may be step-sized and a comparative analysis may be performed utilizing the ratio between the inner wall thickness and the hydraulic diameter to compare the designs. The orientation of the hexagon and the circle are similar, however, the average wall thicknesses vary. Using these equations with an average inner wall thickness on the hexagonal structure of 0.5 mm, the optimal minimum thickness for the circular structure is 0.385 mm. Therefore, the circular structures should be spaced approximately 0.38-0.39 mm apart to substantially increase their performance. These dimensions, however, may be difficult to implement considering current manufacturing limitations. In any case, the circular channel structures should be arranged relative to one another similar to a hexagon arrangement.

The next step involves determining a secondary factor (block 3112), which includes thermal convection, flow stagnation, pressure differentials and/or DRE. Equation 24 calculates a performance factor, I_{TP}.

$${I}_{TP} = \frac{υρ u}{{k}_{s}} \frac{{h}_{Ave}}{Δ p} \qquad ( 24 )$$

Once these factors and the results are determined, it may be determined whether or not to proceed to another analysis with new parameters and/or variables (block 3114).

The kinematic viscosity and other fluid properties are related to the thermal convection and pressure drop. This non-dimensional quantity is useful for optimizing channel densities with respect to fluid properties. With a greater h_{Ave} and a smaller Δp, the circular structure may perform the most effectively if the channels are arranged appropriately.

Utilizing the fluid properties of the air and the hydrodynamic properties of the block with equation 12, it may be shown that the pressure drop will be less for a hexagonal or circular structure than with the square structure. Hence, for this example, a well packed circular structure would provide the most benefit to the system. The outer wall thickness may be two to three times greater than the inner wall thickness for manufacturing stability. The preferred outer wall thickness is identical to the inner wall thickness.

One of the preferred structures, as shown in FIG. 10B, for this example, would be of a circular form with an approximate minimum inner wall thickness of 0.4 mm and an outer wall thickness of approximately 2.0 mm. This geometry maximizes thermal transfer and mass while reducing the pressure drop across the height of the blocks. From test results, it has been estimated that 1.5 m of hexagonal-shaped channel block increases the system efficiency by approximately 1% over a similar square-channeled block. Continuing this trend, the circular-channeled block may potentially have an increase of 1.5% in system efficiency. For example, if a system has been operating with a system efficiency of 93.5% while using 1.5 m of the square-channel structured block, the circular channeled structure may achieve 95% system efficiency, which may represent a potential fuel savings of 15-25%.

Each of the example demonstrated ratios and/or variables may be used to optimize a design with respect to a desired effect or a combination of effects. For the examples described herein, system efficiency and/or plugging are very significant considerations for the system. A system analysis performed with equation 16 and 1B may relate mass and air-flow with respect to efficiency or other system performance factors. A plugging analysis depends greatly on the pollutant concentration whereas the efficiency depends greatly on how well the flow is utilized. Utilizing equations 12 and 16, and an analysis that reveals that the stagnation effect may have a 6.5% effect on the flow, the preferred ratio for thermal efficiency is

$$\frac{{D}_{H}}{{t}_{innerwall}} ∼ 0.58 - 6.53 .$$

This ratio for thermal efficiency is further preferred to be from 2.58 to 5.53 and especially preferred to be from 3.58 to 4.83.

The preferred design to resist agglomeration without protrusions is to have the wall separation as thin as possible and the Dₕ as high as possible. Reducing the operating temperature would also resist plugging. Systems with high silica plugging would perform significantly better with a ratio of

$$\frac{{D}_{H}}{{t}_{innerwall}} ∼ 3.4 - 20.$$

This ratio for plug resistance is further preferred to be from 6.5 to 16.5 and especially preferred to be from 9.0 to 14.0. In some examples, the ratio of

$$\frac{{D}_{H}}{{t}_{innerwall}}$$

is between about 0.5 to 20.0. As the pollutant increases in density, the hydraulic diameter also increases. Since the hydraulic diameter is much greater than t_{wall}, no stagnation effects are prevalent. If the open area becomes relatively large, the block may have diminished thermal effectiveness. Secondary system requirements may be applied as needed per system requirements. The tolerance range of both ratios results from current manufacturing technology and material selection. The example ratios disclosed above are only examples and any appropriate ratio may be applied.

In some examples, a ratio of

$$\frac{{D}_{H}}{{t}_{innerwall}}$$

is approximately 0.085 to 140.0. In some examples where a corrugated profile (e.g., channels with corrugated shapes/profiles) of the blocks is implemented, a ratio of

$$\frac{{D}_{H}}{{t}_{innerwall}}$$

can be approximately 1.0-70.0. In some examples where a structured block of channels is implemented (e.g., circular channels, hexagonal channels, rectangular channels, etc.), a ratio of 0.3 to 50.0 can be implemented.

FIG. 32 is a block diagram of an example processor platform 3200 capable of executing the instructions of FIGS. 30 and 31. The processor platform 3200 can be, for example, a server, a personal computer, a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, or any other type of computing device.

The processor platform 3200 of the illustrated example includes a processor 3212. The processor 3212 of the illustrated example is hardware. For example, the processor 3212 can be implemented by one or more integrated circuits, logic circuits, microprocessors or controllers from any desired family or manufacturer.

The processor 3212 of the illustrated example includes a local memory 3213 (e.g., a cache). The processor 3212 of the illustrated example is in communication with a main memory including a volatile memory 3214 and a non-volatile memory 3216 via a bus 3218. The volatile memory 3214 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 3216 may be implemented by flash memory and/or any other desired type of memory device. Access to the main memory 3214, 3216 is controlled by a memory controller.

The processor platform 3200 of the illustrated example also includes an interface circuit 3220. The interface circuit 3220 may be implemented by any type of interface standard, such as an Ethernet interface, a universal serial bus (USB), and/or a PCI express interface.

In the illustrated example, one or more input devices 3222 are connected to the interface circuit 3220. The input device(s) 3222 permit a user to enter data and commands into the processor 3212. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 3224 are also connected to the interface circuit 3220 of the illustrated example. The output devices 3224 can be implemented, for example, by display devices (e.g., a light emitting diode (LED), an organic light emitting diode (OLED), a liquid crystal display, a cathode ray tube display (CRT), a touchscreen, a tactile output device, a light emitting diode (LED), a printer and/or speakers). The interface circuit 3220 of the illustrated example, thus, typically includes a graphics driver card.

The interface circuit 3220 of the illustrated example also includes a communication device such as a transmitter, a receiver, a transceiver, a modem and/or network interface card to facilitate exchange of data with external machines (e.g., computing devices of any kind) via a network 3226 (e.g., an Ethernet connection, a digital subscriber line (DSL), a telephone line, coaxial cable, a cellular telephone system, etc.).

The processor platform 3200 of the illustrated example also includes one or more mass storage devices 3228 for storing software and/or data. Examples of such mass storage devices 3228 include floppy disk drives, hard drive disks, compact disk drives, Blu-ray disk drives, RAID systems, and digital versatile disk (DVD) drives.

The coded instructions 3232 of FIGS. 30 and 31 may be stored in the mass storage device 3228, in the volatile memory 3214, in the non-volatile memory 3216, and/or on a removable tangible computer readable storage medium such as a CD or DVD.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

1. An apparatus comprising:
a converter including a block having a plurality of channels extending therethrough to receive a gas, the channels to heat or cool the gas, the channels defining a cellular pattern including at least one central channel and a plurality of surrounding channels, wherein protrusions extend into the channels from respective inner surfaces of the channels, and wherein the inner surfaces are defined by respective peripheral walls; and
a switching valve to reverse a direction of flow of the gas through the channels between flow cycles.

2. The apparatus of claim 1, wherein the protrusions extend away from the respective inner surfaces to a distance less than about six times a nominal wall thickness associated with the respective peripheral walls.

3. The apparatus of claim 1, wherein the protrusions are centered on the respective peripheral walls.

4. The apparatus of claim 3, further including corner protrusions located at intersection points of the peripheral walls.

5. The apparatus of claim 4, wherein the corner protrusions have a thickness different from a thickness of other protrusions.

6. The apparatus of claim 4, wherein the corner protrusions have a length different relative to a length of the protrusions.

7. The apparatus of claim 1, wherein at least one of the channels includes multiple protrusions positioned therein.

8. The apparatus of claim 7, wherein the multiple protrusions are spaced asymmetrically relative to a central axis defined by a respective channel of the at least one of the channels.

9. The apparatus of claim 1, wherein at least some of the protrusions include lengths different relative to lengths of others of the protrusions.

10. The apparatus of claim 1, wherein the central channel includes a hydraulic diameter sized relative to a nominal wall thickness associated with the central channel, a proportion between the hydraulic diameter and the thickness being between about 0.085 to 140.0.

11. The apparatus of claim 1, wherein the converter is an oxidizer.

12. The apparatus of claim 1, wherein the peripheral walls are associated with a nominal wall thickness between about 0.085 millimeters to 3 millimeters.

13. The apparatus of claim 1, wherein the cellular pattern is defined by corrugations.

14. An apparatus comprising:
a block for a converter, the block having a plurality of channels extending therethrough to receive a gas, the channels to heat or cool the gas, the plurality of channels defining a cellular pattern including at least one central channel surrounded by a plurality of peripheral channels, wherein a direction of a flow of the gas through the channels is to be reversed between flow cycles; and
a first protrusion extending into the channel from a peripheral wall.

15. The apparatus of claim 14, wherein the first protrusion is tapered.

16. The apparatus of claim 15, wherein the first protrusion includes a first portion positioned on an inner surface of the central channel or the one of the peripheral channels and a second portion extending from the first portion, the first portion being ramped and the second portion having a constant width.

17. The apparatus of claim 14, wherein the first protrusion includes a curved surface.

18. The apparatus of claim 17, wherein the curved surface is formed on a distal end of the first protrusion.

19. The apparatus of claim 17, wherein the first protrusion forms the curved surface with an inner surface defining the central channel or the one of the peripheral channels.

20. The apparatus of claim 14, wherein the first protrusion is disposed on a corrugated wall in the block, the central channel and at least two of the peripheral channels partially formed by the corrugated wall.

21. An apparatus comprising:
a converter including a block having a plurality of channels extending therethrough, the channels defining a cellular pattern including at least one central channel and a plurality of surrounding channels, the channels to receive a gas, the channels to heat or cool the gas, wherein the block includes a plurality of corrugated walls at least partially defining the cellular pattern; and
a switching valve to reverse a direction of flow of the gas through the channels between flow cycles.

22. The apparatus of claim 21, wherein the central channel is formed by a first corrugated wall and a first flat wall extending through the block.

23. The apparatus of claim 22, wherein the first flat wall is interposed between the first corrugated wall and a second corrugated wall of the block.

24. The apparatus of claim 22, wherein at least two of the surrounding channels are formed by the first corrugated wall and a second flat wall extending through the block, the first flat wall and the second flat wall positioned on opposite sides of the first corrugated wall.

25. The apparatus of claim 22, wherein the first corrugated wall includes a plurality of protrusions disposed thereon.

26. The apparatus of claim 25, wherein each of the protrusions is positioned on a single side of the first corrugated wall.

27. A method comprising:
producing a converter including a block having a plurality of channels extending therethrough, the channels defining a cellular pattern including at least one central channel and a plurality of surrounding channels, wherein protrusions extend into the channels from respective inner surfaces of the channels, wherein the inner surfaces are defined by respective peripheral walls.

28. The method of claim 27, wherein producing the converter includes defining the protrusions on a central portion of the respective peripheral walls.

29. The method of claim 27, wherein producing the converter includes defining the protrusions at intersection points formed by adjacent peripheral walls.

30. The method of claim 27, wherein producing the converter includes forming a corrugated wall extending through the block.

31. (canceled)

32. (canceled)

33. (canceled)

34. The apparatus of claim 1, wherein the block is positioned in an environment of approximately 1 bar of pressure.

35. The apparatus of claim 1, wherein the block does not include catalyst materials.

36. A method comprising:
providing a gas to channels of a block of a converter, the channels defining a cellular pattern including at least one central channel and a plurality of surrounding channels, wherein protrusions extend into the channels from respective inner surfaces of the channels, and wherein the inner surfaces are defined by respective peripheral walls; and
reversing a direction of flow of the gas through the channels between flow cycles to heat or cool the gas.
